(19) United States
(12) Patent Application Publication
(10) Pub. No.: US 2018/0090013 A1
(43) Pub. Date: Mar. 29, 2018

(54) UNMANNED AIRCRAFT AND OPERATION THEREOF

(71) Applicant: SHARP Laboratories of America, Inc., Camas, WA (US)

(72) Inventors: Kenneth James PARK, Cathlamet, WA (US); John Michael KOWALSKI, Camas, WA (US)

(21) Appl. No.: 15/712,208

(22) Filed: Sep. 22, 2017

Related U.S. Application Data
(60) Provisional application No. 62/399,044, filed on Sep. 23, 2016.

(51) Int. Cl. G08G 5/00; G05D 1/00; B64C 39/02; H04B 7/185

(52) U.S. Cl. CPC G08G 5/0013; G05D 1/0061; B64C 39/024; G08G 5/0069; G08G 5/006; B64C 2201/146; H04B 7/18506; G05D 1/0022; B64C 2201/021; B64C 2201/141; G08G 5/0021

(57) ABSTRACT

A communications infrastructure (RSU) 30 with its airspace controller 32 provides a geo-fencing system that is capable of adaptive and progressive levels of control authority over the unmanned aircraft system (UAS) e.g., drone 20. The communications infrastructure (RSU) 30 is able to uniquely identify the drone 20, take partial control over the drone 20 to prevent the drone 20 from approaching controlled airspace, take complete control over the drone 20 for the purpose of directing the drone 20 to a specific location via a specific route (i.e. a flight profile), and/or the disabling of the drone 20. The drone 20 includes flight control system 50, vehicle processing system (VPU) 54, and communications system (V2I system) 56. Various data objects are transmitted between the communications system (V2I system) 56 of the drone 20 and the communications infrastructure (RSU) 30. The drone 20 is configured to perform self-check, e.g., of its communications system (V2I system) 56, and to enter a fault mode of operation for overriding propulsion and directionality of the unmanned aerial vehicle during problematic conditions.

This application claims the priority and benefit of U.S. Provisional Patent Application 62/399,044, filed Sep. 23, 2016, entitled “UNMANNED AIRCRAFT AND OPERATION THEREOF”, which is incorporated herein by reference in its entirety.

### TECHNICAL FIELD

The technology relates to operation and control of unmanned vehicles such as aerial vehicles, and particularly to operation and control of such vehicles in view of wireless communications utilized thereby.

### BACKGROUND

The use of unmanned vehicles is increasing and spreading into varied applications, including commerce, military, and geo-surveillance. Some unmanned vehicles, such as “drones”, are aerial. Applications that drive drone adoption and sales include, for example, aerial imaging and data analysis. However, currently the drone industry is facing several challenges, such as legal frameworks and policies, public perception, and safety.

In the above regard, there have been concerns of drones interfering with commercial flight, as in an alleged case of a passenger aircraft supposedly hitting near an airport. Moreover, there has also been concern that drone surveillance may jeopardize personal privacy, or trespass in prohibited air space around governmental or other secure installation.

The U.S. Department of Transportation is requiring U.S. owners of Unmanned Aerial Systems (UAS) having a weight (including payload) of more than 0.55 pounds (250 grams) and less than 55 pounds (approx. 25 kilograms) to register the drones. This is the result of increased drone related accidents and close calls between airplanes and drones flying near the airports. The U.S. government will be coordinating with the drone manufacturers and owners to implement the drone registration system. See, for example, https://www.faa.gov/news/press releases/news story.cfm?newsId=19856

In view of the above and other concerns, consideration has been given as to how geo-fencing can apply to drones. A geo-fence is a virtual perimeter for a real-world geographic area. A geo-fence could be dynamically generated—as in a radius around point location, or a geo-fence can be a predefined set of boundaries. The use of a geo-fence is called geo-fencing, and one example of usage involves a location-aware device of a location-based service (LBS) user entering or exiting a geo-fence.

It has been proposed that drone manufacturers should build geo-fencing constraints into unmanned aerial vehicle navigation systems. Such geo-fencing constraints would, for example, override the commands of the unsophisticated operator, thereby preventing the device from flying into protected airspace. See, for example, U.S. Pat. No. 9,317,036 to Wang, entitled “Flight control for flight-restricted regions”.

The unmanned aerial vehicle comprises a communications system, which in an example embodiment and mode may operate in conjunction with a V2I (Vehicle to Infrastructure) communications service. V2I may be envisioned as a sub-set or specialized type of V2X (Vehicle to Anything) communications service, which in turn may be considered as a subsequent development to as “sidelink direct” communication (e.g., sidelink communication), or even as “sidelink”, “SL”, or “SLD” communication, which previously was also called device-to-device (“D2D”) communication, as explained briefly below.

In terms of the communications terminology used above, it is commonly known that when two user equipment terminals (e.g., mobile communication devices) of a cellular network or other telecommunication system communicate with each other, their data path typically goes through the operator network. The data path through the network may include base stations and/or gateways. If the devices are in close proximity with each other, their data path may be routed locally through a local base station. In general, communications between a network node such as a base station and a wireless terminal is known as “WAN” or “Cellular communication”. But it is also possible for two user equipment terminals in close proximity to each other to establish a direct link without necessarily going through a base station. Telecommunications systems may use or enable device-to-device or sidelink direct communication, in which two or more user equipment terminals directly communicate with one another. In D2D or sidelink communication, voice and data traffic (referred to herein as “communication signals” or “communications”) from one user equipment terminal to one or more other user equipment terminals may not necessarily be communicated through a base station or other network control device of a telecommunication system.

The 3rd Generation Partnership Project (“3GPP”) is a collaboration agreement that aims to define globally applicable technical specifications and technical reports for third and fourth generation wireless communication systems, and in so doing develops suitable 3GPP telecommunications standards. The 3GPP LTE-A system has specified a feature that provides for the support of efficient communications of small data objects between Transmit and Receive devices. Such LTE-A communication of small data objects between Transmit and Receive devices is known as Machine Type Communications (MTC). In this case, the transmitting device may be an eNB and the receiving data may be a UE, or vice-versa.

The 3GPP LTE-A system has also specified a feature that provides for the support of direct communications between transmit and receive devices, known as Proximity Services (ProSe). Proximity services consists of two main elements: network assisted discovery of transmit and receive devices that are in close physical proximity and the facilitation of direct communication between such transmit and receive devices with, or without, supervision from the network.

Currently 3GPP is specifying a new feature for Rel-14 that covers use cases and potential requirements for LTE support for vehicular communications services (represented by the term, Vehicle-to-Everything (V2X) Services). The feature is documented in the TR 22.885 on LTE Study on LTE Support for V2X Services. The documents provide definitions for the following terms:
Road Side Unit (RSU): An entity supporting V2I Service that can transmit to, and receive from a UE using V2I application. RSU is implemented in an eNB or a user equipment (UE).
V2I Service: A type of V2X Service, where one party is a UE and the other party is infrastructure such as an RSU, both using V2I application.
V2P Service: A type of V2X Service, where both parties of the communication are UEs using V2P application.
V2V Service: A type of V2X Service, where both parties of the communication are UEs using V2V application.
V2X Service: A type of communication service that involves a transmitting or receiving UE using V2V application via 3GPP transport. Based on the other party involved in the communication, it can be further divided into V2V Service, V2I Service, V2P Service, and V2N Service.

What is needed are methods, apparatus, and/or techniques for controlling unmanned vehicles using the particular communications systems utilized thereby.

### SUMMARY

In one of its various example aspects the technology disclosed herein concerns an unmanned aerial vehicle comprising a flight controller, communications circuitry, transceiver circuitry, and processor circuitry. The flight controller is configured to provide signals to propulsion and directionality mechanisms of the unmanned aerial vehicle. The communications circuitry is configured to participate in vehicle-to-infrastructure (V2I) communications with an entity supporting V2I communications. The transceiver circuitry comprises an antenna configured to transceive wireless signals of the V2I communications. The processor circuitry is configured: to detect a fault in the vehicle or in a communications link between the vehicle and the entity supporting V2I communications; and upon detecting the fault, to direct the flight controller to follow a fault mode of operation for overriding propulsion and directionality of the unmanned aerial vehicle.

In another of its example aspects the technology disclosed herein concerns a method in an unmanned aerial vehicle. In a basic mode the method comprises: a flight controller providing signals to propulsion and directionality mechanisms of the unmanned aerial vehicle; detecting a fault in the vehicle or in a communications link between the vehicle and an entity supporting V2I communications; and upon detecting the fault, directing the flight controller to follow a fault mode of operation for overriding propulsion and directionality of the unmanned aerial vehicle.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing generally three scenarios which may occur in vehicle (V2X) communication, i.e., an in coverage vehicle (V2X) communication scenario; a partial coverage vehicle (V2X) communication scenario; and an out-of-coverage vehicle (V2X) communication scenario.

FIG. 2 is a diagrammatic view showing that, in differing implementations, V2X communication may be implemented either in conjunction with sidelink direct (SLD) communication, in conjunction with enhanced SLD, or apart from SLD as a separate V2X communication protocol.

FIG. 3A and FIG. 3B are diagrammatic views showing an unmanned aerial vehicle or drone approaching a controlled airspace according to different example embodiments and modes, with FIG. 3A showing the controlled air space located about a stationary entity supporting V2I communications and FIG. 3B showing the controlled air space located about a mobile entity supporting V2I communications.

FIG. 4 is a schematic view of example elements comprising a drone according to an example embodiment and mode.

FIG. 5 is a schematic view of example elements comprising a communications infrastructure for controlled airspace according to an example embodiment and mode.

FIG. 6 is a diagrammatic view of an example Controlled Area Data Object (CADO) according to an example embodiment and mode.

FIG. 7 is a diagrammatic view of an example VPU Command Object (VCO) according to an example embodiment and mode.

FIG. 8 is a diagrammatic view of an example Vehicle Data Object (VDO) according to an example embodiment and mode.

FIG. 9 is a flowchart illustrating example, basic acts or steps comprising executed by processor circuitry of drone for authenticating flight commands.

FIG. 10 is a flowchart illustrating example, basic acts or steps executed by processor circuitry comprising drone location determination unit (DLU) in an example embodiment and mode.

FIG. 11 is a flowchart illustrating example, basic acts or steps executed in conjunction with an authentication procedure of the technology disclosed herein.

FIG. 12 is a flowchart illustrating example, basic acts or steps executed in conjunction with a communications failure detection procedure of the technology disclosed herein.

FIG. 13 is a diagrammatic view illustrating differing relationships—“contained in”, “overlapped”, and “not overlapped”—of plural controlled airspaces.

FIG. 14 is a flowchart showing basic acts or steps comprising operation of an unmanned air vehicle according to aspects of the technology disclosed herein.

FIG. 15 is a diagrammatic view showing example elements comprising electronic machinery which may comprise either a drone or a communications infrastructure (RSU) according to an example embodiments and modes.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “device-to-device (“D2D”) communication” may refer to a mode of communication between or among wireless terminals that operate on a cellular network or other telecommunications system in which the communication data traffic from one wireless terminal to another wireless terminal does not pass through a centralized base station or other device in the cellular network or other telecommunications system. The “device-to-device (D2D) communication” encompasses one or both of D2D signaling (e.g., D2D control information) and D2D data. “Device-to-device (“D2D”) communication may also be known as “sidelink direct” communication (e.g., sidelink communication). The term “sidelink direct” may also be shortened to “sidelink”, abbreviated as “SL”, and as such “sidelink” may be used herein to refer to sidelink direct. Yet further, the term “ProSe” (Proximity Services) direct communication may be used in lieu of sidelink direct communication or device-to-device (D2D) communication. Therefore, it is to be understood that herein the terms “sidelink direct”, “sidelink” (SL), “ProSe” and “device-to-device (D2D)” may be interchangeable and synonymous.

Thus, as mentioned above, device-to-device (D2D) or sidelink direct communication differs from “WAN” or “Cellular communication” which is or involves communication between the base station and the wireless terminal. In device-to-device (D2D) communication, communication data is sent using communication signals and can include voice communications or data communications intended for consumption by a user of a wireless terminal. Communication signals may be transmitted directly from a first wireless terminal to a second wireless terminal via D2D communication. In various aspects, all, some or none of the control signaling related to the D2D packet transmission may be managed or generated by the underlying core network or base station. In additional or alternative aspects, a receiver user equipment terminal may relay communication data traffic between a transmitter user equipment terminal and one or more additional receiver user equipment terminals.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (e.g., for New Radio [“NR”] technology), or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information.

As used herein, vehicle (V2X) communication is a communication that involves a radio connection established between a transmit device and a receive device (e.g., a wireless terminal or UE), which radio communication does not transit via a base station node of the network, with at least of one the transmit and the receive devices being mobile, e.g., capable of being moved. Generic V2X encompasses one or more of vehicle to infrastructure (V2I) communication; vehicle to person/pedestrian (V2P) communication; and vehicle to vehicle (V2V) communication. As used herein, V2X also encompasses X2V, e.g., reference to V2I also means I2V.

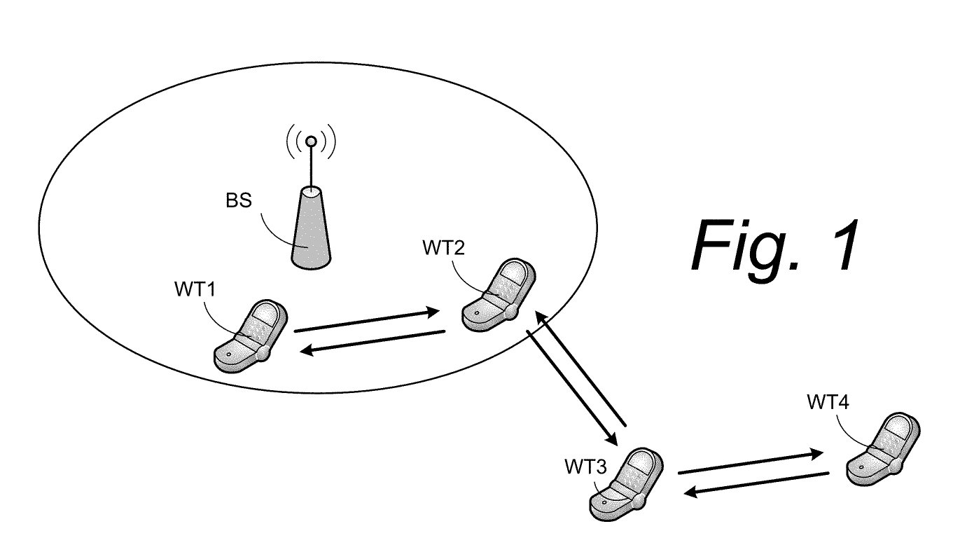

Generally, there are three general scenarios which may occur in vehicle (V2X) communication. Those three general vehicle (V2X) communications scenarios are illustrated in FIG. 1. A first vehicle (V2X) communication scenario is an “in coverage” vehicle (V2X) communication scenario, illustrated between WT1 and WT2 of FIG. 1, in which both WT1 and WT2 are within coverage of the radio access network. A second vehicle (V2X) communication scenario is a “partial coverage” scenario, illustrated between WT2 and WT3 of FIG. 1. In the “partial coverage” vehicle (V2X) communication scenario the wireless terminal WT2 is within coverage of the radio access network, but the wireless terminal WT3 is out-of-coverage of the radio access network. A third vehicle (V2X) communication scenario is an “out-of-coverage” scenario, illustrated between wireless terminal WT3 and wireless terminal WT4 of FIG. 1. In the out-of-coverage vehicle (V2X) communication scenario both the wireless terminal WT3 and the wireless terminal WT4 are out-of-coverage of the radio access network.

The three vehicle (V2X) communication scenarios are described with reference to whether or not a participating wireless terminals (e.g., WTs) are “in coverage” or “out-of-coverage” of one or more radio access networks (which may collectively be referred to as a “radio access network”). For sake of simplicity FIG. 1 depicts “coverage” as being with respect to an access node BS such as eNodeB which comprises a radio access network. It should be understood, however, that a wireless terminal may also be in coverage of the radio access network when served by any cell of the radio access network(s). For example, if wireless terminal WT1 and wireless terminal WT2 were served by different cells, when participating in vehicle (V2X) communication the wireless terminal WT1 and wireless terminal WT2 would still be in an in coverage vehicle (V2X) communication scenario.

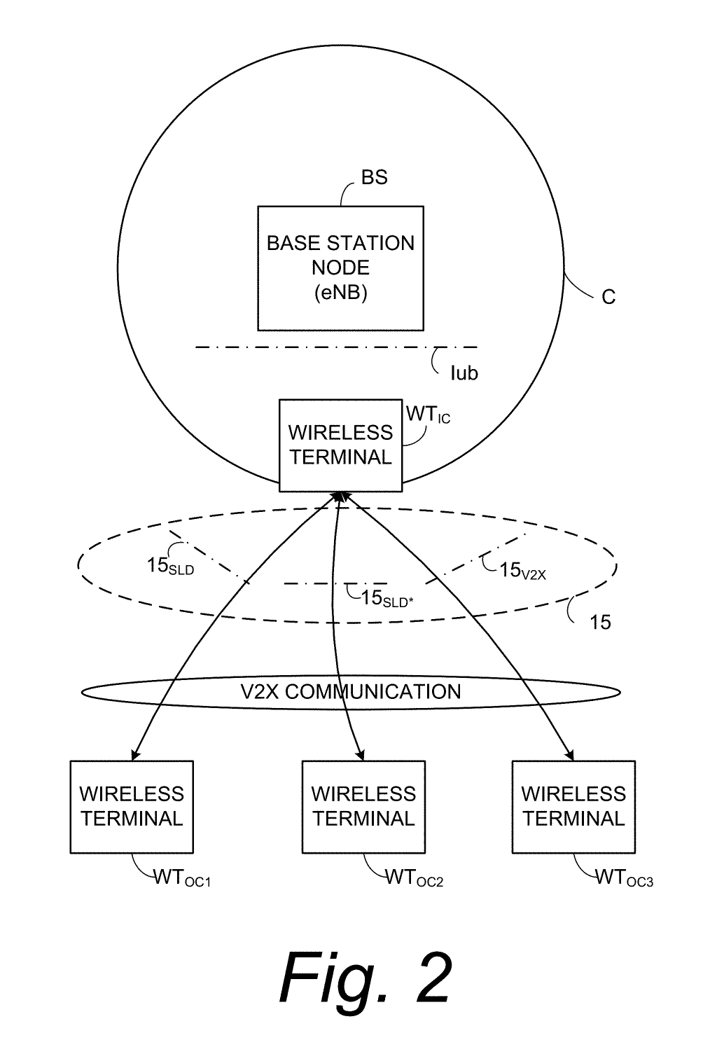

As used herein and as illustrated in FIG. 2, V2X communication may be implemented in several ways. For illustrative context, FIG. 2 illustrates a base station node BS of a radio access network which serves a cell C. The base station BS may communicate with a wireless terminal WT_{IC} which is in coverage of the radio access network over a radio interface Uu. FIG. 2 further shows that wireless terminal WT_{IC} may engage in vehicle (V2X) communication with one or more other wireless terminals which are outside of coverage of the radio access network, particularly wireless terminal WT_{OC1}, wireless terminal W_{TOC2, and} wireless terminal W_{TOC3}. It is assumed that either wireless terminal WT_{IC}, or all of wireless terminal WT_{OC1}, wireless terminal W_{TOC2, and} wireless terminal WT_{OC3} are mobile terminals for the communication to be vehicle (V2X) communication. Being “mobile” means that the wireless terminal is provided or situated in/with a mobile entity, such as a vehicle or a person.

As a first example implementation, V2X communication may be implemented using applications and resources of the type that were utilized for sidelink direct (SLD) communication (also known as device-to-device (“D2D”) communication) before introduction of vehicle (V2X) communication. For example, when implemented as part of SLD communication the V2X communication may use resources and channels of the SLD communication scheme. In such first implementation the V2X communication may be said to be implemented using pre-V2X sidelink direct (SLD) protocol and over a pre-V2X sidelink direct (SLD) radio interface 15SLD.

As a second example implementation, V2X communication may be implemented using enhanced applications and enhanced resources utilized for sidelink direct (SLD) communication, e.g., sidelink direct communications augmented or enhanced with additional capabilities to accommodate vehicle (V2X) communication. In such second implementation the V2X communication may be said to be implemented using enhanced sidelink direct (SLD) protocol and over an enhanced sidelink direct (SLD) radio interface 15SLD*.

As a third example implementation, V2X communication may operate separately from sidelink direct (SLD) communication by, e.g., having separate and dedicated V2X communication resources and channels, and by being performed using application software which is specific to V2X communication. In such third implementation the V2X communication may be said to be implemented using separate vehicle (V2X) communications protocol and over a separate vehicle (V2X) communication radio interface 15V2X.

The fact that three example implementations are illustrated in FIG. 2 does not mean that a particular wireless terminal has to participate in all three or even two of the example implementations. FIG. 2 simply indicates the expansive meaning of the term vehicle (V2X) communication and that the technology disclosed herein encompasses vehicle (V2X) communication in all of its various existing and potential implementations.

### 1.0 Structure: Overview

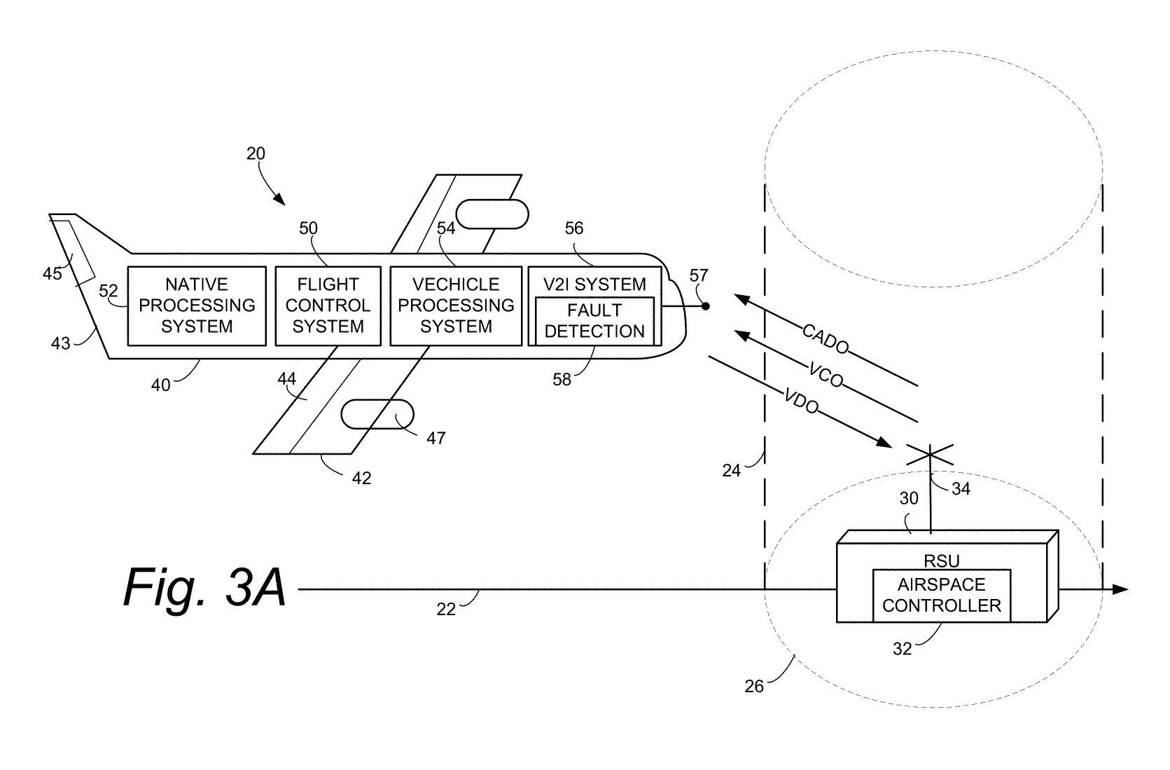

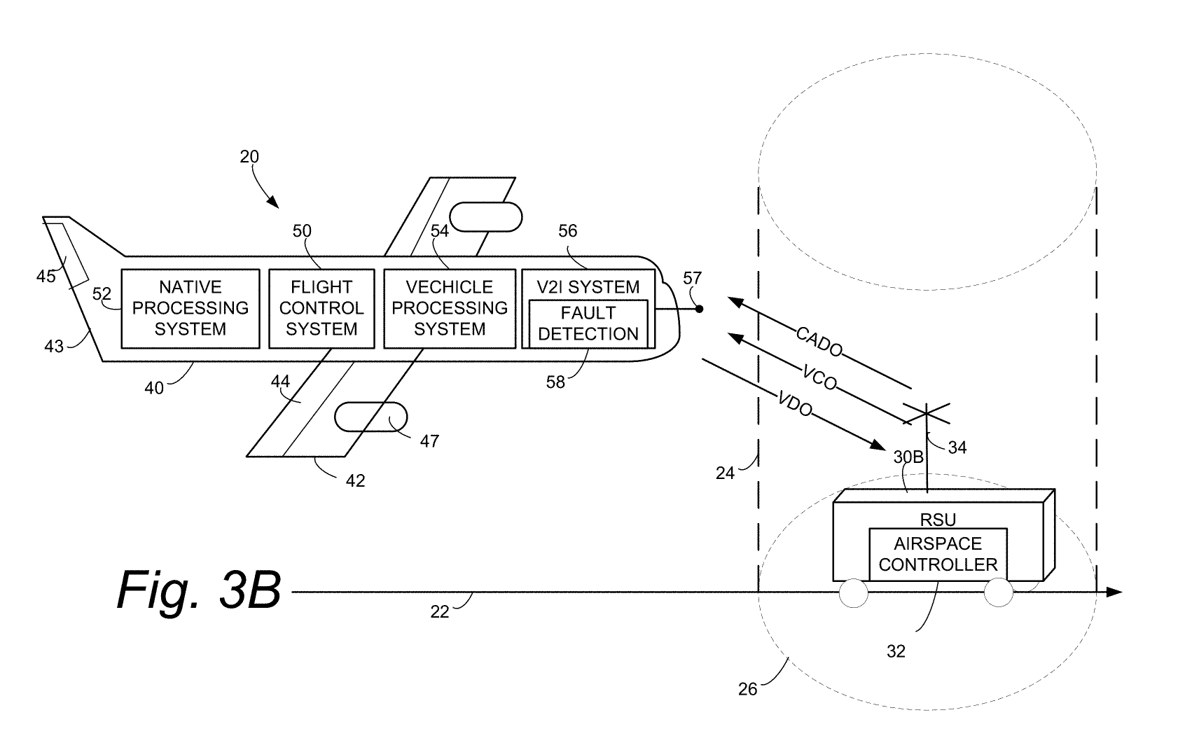

FIG. 3A and FIG. 3B shows an unmanned aerial vehicle 20 in flight and headed in a direction depicted by arrow 22. The unmanned aerial vehicle 20 may also be referred to as “unmanned aircraft system” (UAS), or “unmanned aircraft”, or simply and usually herein as “drone”. In the particular scenarios shown in FIG. 3A and FIG. 3B, the drone 20 is approaching controlled airspace 24 which is diagrammatically represented by broken line. For the particular example situations shown in FIG. 3A and FIG. 3B, the controlled airspace 24 may be visualized as cylindrically space volume 24 having base 26. Communications infrastructure 30, also known as an entity supporting V2I communications, is associated with the controlled airspace 24, and preferably located within the controlled airspace 24 (e.g., at the center of base 26). As described further herein, the communications infrastructure or entity supporting V2I communications comprises communications circuitry or apparatus which includes at least processor circuitry and transceiver circuitry suitable for engaging in V2I communications. The controlled airspace 24 may have other volumetric configurations, and may actually comprise plural airspaces. In view of the fact that the communications infrastructure 30 may function much like a roadside unit (RSU) of V2I communications, the communications infrastructure 30 is labeled and often referred to herein as RSU 30. The appellation of “RSU” does not mean, however, that the communications infrastructure 30 need necessarily to be located along a road or at any other specific geographical location, other than a location suitable for communicating in a manner to govern or protect the controlled airspace 24. To this end, communications infrastructure 30 is provided with airspace controller 32 as well as one or more infrastructure antennae 34.

In essence, the communications infrastructure 30 with its airspace controller 32 provides a geo-fencing system that is capable of adaptive and progressive levels of control authority over the unmanned aircraft system (UAS) e.g., drone 20. Such a system provides, e.g., a means for public safety operator to: uniquely identify the drone 20, take partial control over the drone 20 to prevent the drone 20 from approaching controlled airspace, take complete control over the drone 20 for the purpose of directing the drone 20 to a specific location via a specific route (i.e. a flight profile), and/or the disabling of the drone 20.

FIG. 3A happens to illustrate the communications infrastructure 30, e.g., the entity supporting V2I communications, as a stationary entity 30A. The stationary entity 30A may take the form of a structure, such as a building or a tower, for example. On the other hand, FIG. 3B illustrates the communications infrastructure 30 as being mobile, e.g., a mobile entity supporting V2I communications 30B. The mobile entity supporting V2I communications 30B may be mobile in terms of movement on earth, e.g., such as mounted on or carried by a moving land-based vehicle. For example, if a motorcade with a dignitary or head of state were driving down a highway, it would be prudent to make sure that no drones are able to enter the “area” surrounding the motorcade as it transits from point A to point B. Given that the distance from point A to point B may be very large (e.g., 100 miles) it may not be desirable/practical to restrict all airspace for the 100 mile route. Also, the route may change from original plan. So, it may be desirable to place the RSU base station in a vehicle that is part of the motorcade. Thus the protected area may be defined as a Smiles radius that moves with the motorcade. As the motorcade moves the mobile RSU base station continuously broadcasts an updated CADO to define new coverage area.

The mobile entity supporting V2I communications 30B may be mobile in terms of movement in the air (e.g., such as mounted on or carried by a helicopter or plane), or in water (e.g., such as mounted on or carried by a ship). In the case of an air-mobile entity supporting V2I communications, the shape of the volume of the controlled air space may be, for example, a sphere.

As used herein, generic reference to the “communications infrastructure 30” or to the entity supporting V2I communications” may refer either to the stationary entity (e.g., the stationary entity supporting V2I communications 30A) or to the mobile entity (e.g., the mobile entity supporting V2I communications 30B).

Whether stationary or mobile, the entity supporting V2I communications has a backhaul (which, unlike a V2V entity) allows the V2I entity to access, in real time, data from remote service such as a governmental or institutional data base of drone identifiers (e.g., Federal Communications Commission database). The V2I backhaul also allows the entity supporting V2I communications to have command and control from some remote command center, which may be coordinating and controlling other entities, possibly including mobile entities (e.g., a network of mobile entities that would modify their CADOs in relation to each other).

### 1.1 Structure: Unmanned Aircraft (Drone)

The drone 20 is illustrated in FIG. 3A and FIG. 3B as having fuselage 40 similar to that of a conventional aircraft. The drone 20 further comprises wings 42 and tail 43, which respectively comprise wing flags 44 and tail flaps 45. The wing flags 44 and tail flaps 45 are configured to provide directionality for drone 20, and therefore are also collectively referred to as directional mechanisms 46 for drone 20. The drone 20 further comprises one or more engines, such as engine(s) 47, which may be situated at any suitable location relative to the wings 42 or fuselage 40. The engine(s) 47 are also referred to herein as propulsion mechanism 48, and may be of any suitable type. It should be understood that while drone 20 has been depicted in FIG. 3A and FIG. 3B in a manner similar to conventional aircraft, that the overall structure of the drone 20 may assume other shapes and configurations, and that other types of airfoils and propulsion systems may be utilized. For example, the drone 20 may have a helicopter type configuration, or even that of a multi-legged structure with plural propeller-borne arms emanating from a central body. In this regard, as used herein, the term “fuselage” is not to be limited to the shape and configuration of aircraft, but to encompass any aircraft shell structure suitable for housing payload and/or electronics.

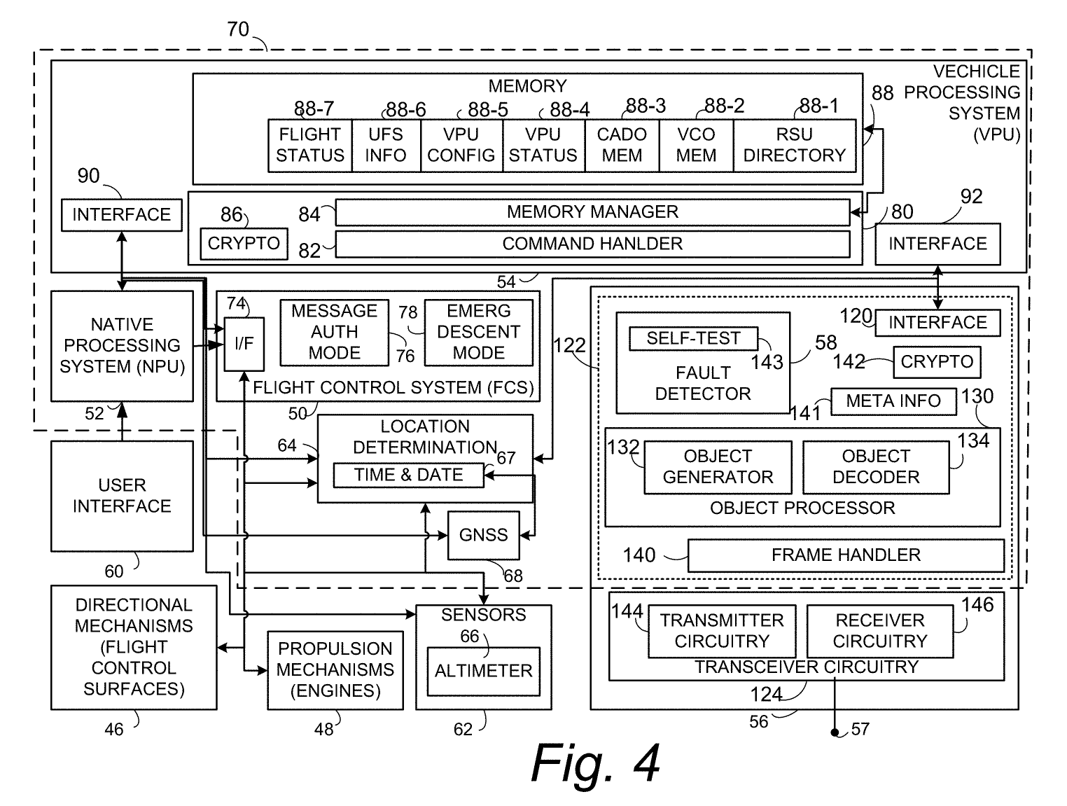

In addition to its fuselage 40 and other physical structures, the drone 20 comprises electronics illustrated in FIG. 3A and FIG. 3B. In the example embodiment and mode of FIG. 3A and FIG. 3B the electronics of drone 20 comprises flight control system 50, native processing system (NPU) 52, vehicle processing system (VPU) 54, and communications system (V2I system) 56. The communications system (V2I system) 56 as shown in FIG. 3A and FIG. 3B as comprising (or being operatively connected to) one or more drone communications antennae 57, as well as drone communication fault detection controller 58. While illustrated diagrammatically in FIG. 3A and FIG. 3B as being borne by fuselage 40, FIG. 4 shows in more detail interconnections and constituent components of these electronic systems and in schematic representation.

As illustrated in FIG. 4, drone 20 may also comprise drone user interface 60 which is configured to permit user interaction (such as programming) of drone electronics, such as interaction with native processing system (NPU) 52. The drone user interface 60 may comprise any suitable input and output devices, including but not limited to keyboard, mouse, display screen (which may be a touch screen or interactive), microphone, or haptic device. FIG. 4 further shows flight control system 50 as being connected not only to directional mechanisms 46 and propulsion mechanism 48, but also to drone onboard sensors 62 and drone location determination unit (DLU) 64. A non-limiting example of a drone sensor 62 is drone altimeter 66. The drone location determination unit (DLU) 64 may comprise, for example, time and date acquisition unit 67. The onboard sensors 62 may comprise Processing Radar Altimeter, Laser Range Finder, Acoustic Range Finder, Optical Range Finder, Accelerometers, Pressure Altimeter, Magnetic, Thermal, Electrical, and Proximity sensing devices. The drone electronics may also comprise Global Navigation Satellite System (GNSS) 68, which may also be considered an onboard sensor.

It should be appreciated that many of the electronic elements and units of drone 20 as shown in FIG. 4 may be realized by one or more processors, e.g., processor circuitry 70, including but not necessarily limited to the elements encompassed by the broken line labeled as processor circuitry 70 in FIG. 4. In some instances various elements or units may also be labeled herein as processors or controllers, in which case such elements may comprise or share execution with other elements comprising processor circuitry 70 or may be distinct processors included in processor circuitry 70. In a processor embodiment and mode, processor circuitry 70 executes instructions stored on non-transient media, e.g., a memory such as memory comprising one or more of flight control system 50, native processing system (NPU) 52, vehicle processing system (VPU) 54, and/or communications system (V2I system) 56.

The technology disclosed herein thus encompasses, e.g., the communications infrastructure 30 associated with controlled airspace 24 as well as the unmanned aircraft system (UAS) or drone 20 itself, including various components of the drone 20 such as (for example) flight control system 50 (a native component of the UAS), vehicle processing system (VPU) 54 (which may be integrated into flight control system 50), and communications system (V2I system) 56 (which may be integrated into the vehicle processing system (VPU) 54). Selected systems, functionalities, and units of drone 20 and communications infrastructure (RSU) 30 are described hereinafter in more detail.

### 1.1.1 Structure: Flight Control System (FCS)

The flight control system (FCS) 50 is configured to manage the flight control surfaces (e.g., directional mechanisms 46) of drone 20 to effect the intended and stable flight path of the drone 20. The flight control system 50 provides comprises an FCS interface (I/F) 74 through which the flight control system 50 abstracts the operation of the directional mechanisms 46 and/or propulsion mechanism 48 from the flight commands received from the native processing system (NPU) 52 and vehicle processing system (VPU) 54. The FCS interface 74 also is connected to one or more drone sensors 62 and to drone location determination unit (DLU) 64. In addition, as shown in FIG. 4, the flight control system 50 may comprise logic for executing various modes, including message authentication mode logic 76 and emergency descent mode logic 78.

### 1.1.2 Structure: Vehicle Processing System (VPU)

In an example embodiment and mode, vehicle processing system (VPU) 54 comprises VPU processor 80, which in turns comprises VPU command handler 82, VPU memory manager 84, and VPU cryptographic unit 86. The VPU memory manager 84 manages, e.g., performs input and output operations, for VPU memory 88. The VPU memory 88 is configured or structured to store various types of information pertinent to operation to drone 20 and to vehicle processing system (VPU) 54 in particular. Among the information stored in VPU memory 88 are RSU directory 88-1; VCO records 88-2; CADO records 88-3, VPU status records 88-4; VPU configuration records 88-5; UFS information records 88-6; and flight status records 88-7. The vehicle processing system (VPU) 54 also comprises an interface 90 through which vehicle processing system (VPU) 54 communicates with flight control system 50, native processing system (NPU) 52, drone sensors 62, and drone location determination unit (DLU) 64; as well as interface 92 through which vehicle processing system (VPU) 54 communicates with communications system (V2I system) 56.

The vehicle processing system (VPU) 54 is configured to collate, interpret and act upon data related to the interaction of the drone 20 and the controlled airspace 24. The vehicle processing system (VPU) 54 is configured to command and control functions that, among other function, may override the native UAS flight control system, e.g., the native processing system (NPU) 52. The vehicle processing system (VPU) 54 may command the communications system (V2I system) 56 to transmit data to the RSU 30. The vehicle processing system (VPU) 54 may receive commands and exchange data with the RSU 30 via the communications system (V2I system) 56. In an example implementation, vehicle processing system (VPU) 54 may be integrated into the flight control system 50 that is native to the drone 20, and may send commands to the flight control system 50 as a means to execute control over the flight operations of the drone 20. In an example embodiment and mode, vehicle processing system (VPU) 54 may be integrated into the flight control system 50 to at least the same extent as native processing system (NPU) 52. The vehicle processing system (VPU) 54 may receive data from the flight control system 50. The vehicle processing system (VPU) 54 may send data and commands to, and received data from, the drone location determination unit (LDU) 64. The vehicle processing system (VPU) 54 may send data and commands to, and received data from, other sensors onboard the drone 20 (e.g. pressure altimeter 66).

In an example embodiment and mode vehicle processing system (VPU) 54 may be configured with an interface (such as interface 90) to other data processing and data generation devices, units, or systems that are also onboard the UAS (for example, the native processing system (NPU) 52, the drone location determination unit (DLU) 64 (including coordination determination unit 68). The flight control system (FCS) 50, vehicle processing system (VPU) 54, communications system (V2I system) 56, GNSS 68, and drone location determination unit (DLU) 64 may be separate physical units that interface via a common or dedicated communication interface, or they may be distinct logical units in a single integrated unit or any combination of logical and physical units. The vehicle processing system (VPU) 54 may be configured at time of manufacture with a “VPU Unique ID”, and the drone 20 may be configured at time of manufacture with a “UAS Unique ID. The “VPU Unique ID” may or may not be equivalent to the “UAS Unique ID”.

### 1.1.3 Structure: Drone Location Determination Unit

In an example embodiment and mode the drone location determination unit (LDU) 64 is configured to provide spatial location data to the vehicle processing system (VPU) 54. In an example implementation the LDU output may be based on data obtained from a Global Navigation Satellite System (GNSS) and/or other location determination systems, and one or more of the onboard sensors 66, such as drone altimeter 66.

### 1.1.4 Structure: Native Processing System (NPU)

The native processing system (NPU) 52 is responsible for interfacing to the flight control system 50 and providing flight commands received by the native radio unit. The native radio unit is in communication with the native user control unit. The native user control unit takes input from the UAS user, e.g., via drone user interface 60. Aspects of the native processing system (NPU) 52 and other native features/functions are not described here other than to identify its shared used of the common interface to the flight control system (FCS) 50.

### 1.1.5 Structure: Communications System (V2I System)

As shown in FIG. 4, in an example embodiment and mode communications system (V2I system) 56 comprises V2I/VPU interface 120; V2I processor 122 (which may comprise or work in conjunction with processor circuitry 70); and drone transceiver (transceiver circuitry) 124. The V2I processor 122 comprises communication object processor 130, which in turn comprises communication object generator 132 and communication object decoder/interpreter 134. The V2I processor 122 further comprises frame handler 140, as well as communication meta information memory 141, V2I cryptographic unit 142, and the previously described drone communication fault detection controller 58. As shown in FIG. 4, in example embodiments and modes the drone communication fault detection controller 58 comprises self-test functionality 143.

The drone transceiver 124 is connected to drone communications antennae 57, and comprises transmitter circuitry 144 and receiver circuitry 146. Drone transmitter circuitry 144 includes, e.g. amplifier(s), modulation circuitry and other conventional transmission equipment. Drone receiver circuitry 146 comprises, e.g., demodulation circuitry and other conventional receiver equipment. The drone transceiver circuitry 124 is configured to use resources allocated for V2I communication, whether those resources be shared with sidelink direct (SLD) communications, resources of enhanced sidelink direct (SLD) communications, or resources separate and distinct for V2I communication as previously described.

In example embodiments and modes communications system (V2I system) 56 is responsible for receiving information transmitted by the communications infrastructure (RSU) 30, and for transmitting Vehicle Data Objects (VDO) to the communications infrastructure (RSU) 30. The communications system (V2I system) 56 may use the LTE Side-link protocol communicate with the communications infrastructure (RSU) 30. Alternately the communications system (V2I system) 56 may use the Uu protocol to communicate with the communications infrastructure (RSU) 30. The communications system (V2I system) 56 is connected to the vehicle processing system (VPU) 54, and may pass messages received from the communications infrastructure (RSU) 30 (e.g., Controlled Area Data Object (CADO) and VPU Command Object (VCO)) to the vehicle processing system (VPU) 54. The communications system (V2I system) 56 may receive from the vehicle processing system (VPU) 54 a message to be transmitted to the communications infrastructure (RSU) 30 (i.e. Vehicle Data Object (VDO)). In example embodiments and modes the communications system (V2I system) 56 may comprise VPU cryptographic unit 142 and thus may employ cryptographic procedures (i.e. Message Authentication Code (MAC)) to authenticate the data received from the vehicle processing system (VPU) 54. Using V2I cryptographic unit 142 the communications system (V2I system) 56 may employ cryptographic procedures (i.e. a Public-key encryption) to protect data sent by communications system (V2I system) 56 to communications infrastructure (RSU) 30.

### 1.2 Structure: Communications Infrastructure (RSU)

The communications infrastructure (RSU) 30, whether taking the form of a stationary entity supporting V2I communications 30A or a mobile entity supporting V2I communications 30B, is configured to broadcast information related to the identification of and/or definition of an area of controlled airspace(s) 24 (e.g., the Geo-Fence), information related to the status of the controlled airspace(s) 24 (e.g., whether the controlled airspace 24 is “Prohibited”, “Restricted”, or “Monitored”), system commands (e.g. UAS identification request), and system configuration data (e.g. flight control parameters, flight profiles). In an example embodiment and mode the communications infrastructure (RSU) 30 is non-network controlled and not reliant on the resources of a commercial network. However, the communications infrastructure (RSU) 30 is not precluded from using the resources of a commercial network and coordinated with said network for use of its resources. The communications infrastructure (RSU) 30 is configured to receive data transmitted by the communications system (V2I system) 56.

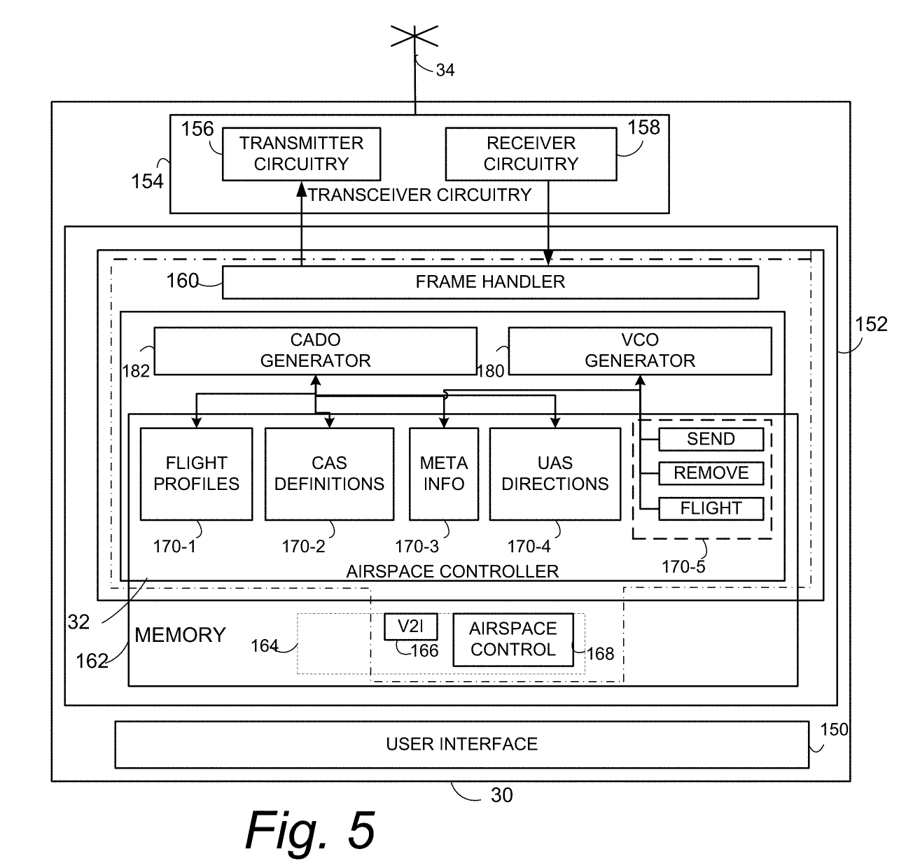

FIG. 5 shows an example embodiment and mode of communications infrastructure (RSU) 30 as comprising RSU user interface 150; RSU processor circuitry 152, and RSU transceiver 154. The RSU transceiver 154 is connected to RSU communications antennae 34, and comprises RSU transmitter circuitry 156 and RSU receiver circuitry 158. RSU transmitter circuitry 156 includes, e.g., amplifier(s), modulation circuitry and other conventional transmission equipment. RSU receiver circuitry 158 comprises, e.g., demodulation circuitry and other conventional receiver equipment. In an example embodiment and mode RSU transceiver circuitry 152 is configured to use resources allocated for V2I communication, whether those resources be shared with sidelink direct (SLD) communications, resources of enhanced sidelink direct (SLD) communications, or resources separate and distinct for V2I communication as previously described.

The RSU user interface 150 is configured to permit user interaction (such as programming) of the communications infrastructure (RSU) 30, including activation of and defining of parameters for airspace controller 32. The RSU user interface 150 may comprise any suitable input and output devices, including but not limited to keyboard, mouse, display screen (which may be a touch screen or interactive), microphone, speaker(s), and haptic devices.

The RSU processor circuitry 152 comprises airspace controller 32 and frame handler 160, and RSU memory 162. The RSU memory 162 includes applications 164 executed by one or more processors of communications infrastructure (RSU) 30, including V2I application 166 and an airspace control application 168 which is executed by airspace controller 32 of RSU processor circuitry 152 in particular. The RSU memory 162 also includes memory locations 170 which store information pertinent to the operation of airspace controller 32, such as memory locations for flight profile records 170-1; for CAS definitions 170-2; for meta information records 170-3; for drone direction records 170-4; and for various commands (170-5) such as send commands, remove commands, and flight commands. The information stored in one or more of the memory locations may be access and/or maintained by VCO generator 180 and CADO generator 182 which comprise airspace controller 32. Whereas the definition of the controlled airspace(s) 24 may be referenced with respect to a fixed or stationary point for the stationary entity supporting V2I communications 30A of FIG. 3A, a reference point for defining the controlled airspace(s) 24 may change for a mobile entity supporting V2I communications 30B of FIG. 3B as the location of the mobile entity supporting V2I communications 30B changes during transit. Likewise, with a changed location of the mobile entity supporting V2I communications 30B and thus a change of the definition of the protected airspace(s) 24, other records and/or definitions (such as flight profile records 170-1) may also change in view of the transit.

The communications infrastructure (RSU) 30 may employ cryptographic procedures (i.e. a Public-key encryption) to protect data sent by the communications infrastructure (RSU) 30 to the communications system (V2I system) 56.

The communications infrastructure (RSU) 30 is responsible for receiving information transmitted by communications system (V2I system) 56 of drone 20. The communications infrastructure (RSU) 30 is also responsible for broadcasting Controlled Area Data Objects (CADO), and VPU Command Objects (VCO), discussed below. The communications infrastructure (RSU) 30 may transmit information that is intended for all V2I devices that may receive it (i.e. global or default addressing), or to a set of V2I devices (i.e. group addressing), or to a specific V2I device (i.e. a unique address). The communications infrastructure (RSU) 30 may use the LTE Side-link protocol to communicate with a V2I. Alternately the communications infrastructure (RSU) 30 may use the Uu protocol to communicate with a V2I.

### 1.3 Structure: Communications Objects

As mentioned above, the communications infrastructure (RSU) 30 is responsible for broadcasting Controlled Area Data Objects (CADO), and VPU Command Objects (VCO). The communications system (V2I system) 56 may send Vehicle Data Objects (VDO) to communications infrastructure (RSU) 30.

### 1.3.1 Structure: Controlled Area Data Objects (CADO)

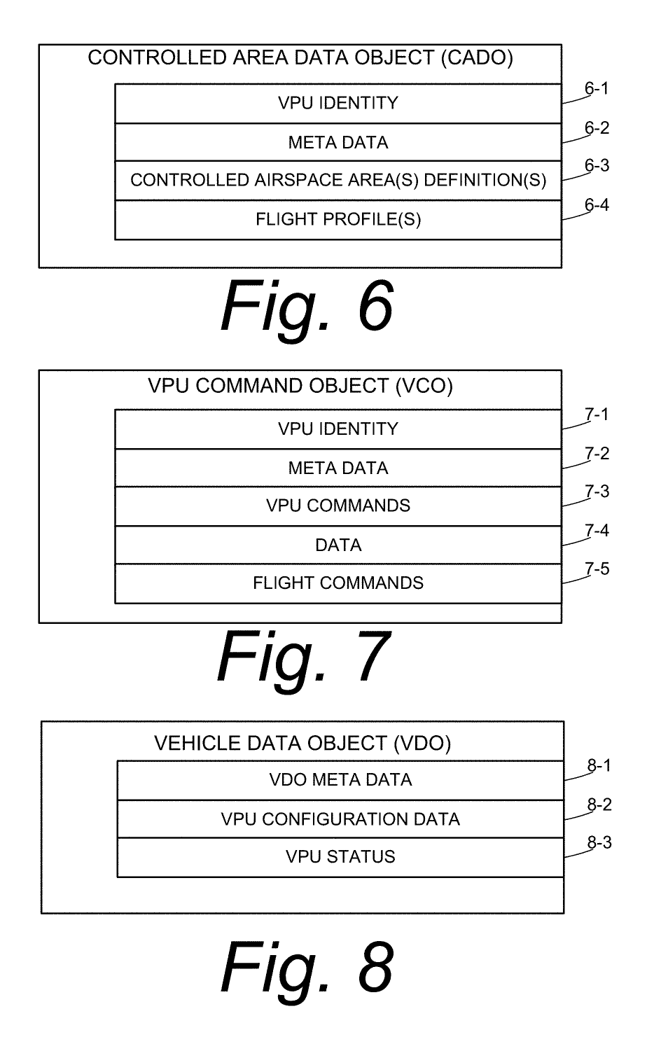

As illustrated in FIG. 6, a Controlled Area Data Object (CADO) may comprise various information elements (IEs) or fields, including but not limited to the following:

IE 6-1: The identify used to address the VPU that this CADO is for:
Global (or Default) ID
Group ID
VPU Unique ID

IE 6-2: Meta-data for this CADO
The unique ID for this CADO
Date and time stamp of when CADO was broadcast (i.e. RSU System Time)
The expiration Date and Time for this CADO.
Priority level

IE 6-3: The definition of one or more 3-D areas of “Controlled Airspace”: CAS1, CAS2 . . . CASn
A CAS may be defined by
   A polyhedron, via a polygon mesh as a collection of vertices, edges and faces that defines the shape of a polyhedral object in 3D, such that the set of vertices represent X, Y and Z coordinates relate to Latitude, longitude and Altitude, and an edge is a connection between two vertices, and face is a closed set of edges,
   One or more vertices and a radius from each vertices.
The relationship between areas defined by CAS₁ . . . CASₙ may be such that they are:
   “Fully Contained”, where each CAS encapsulates the other CAS.
      E.g. The area of CAS₁, contains all the area of CAS₂, and the area of CAS₂ contains all the area of . . . CASₙ
   “Overlapped”, where each CAS shares some common area with other CAS.
      E.g. The area of CAS₁, contains some of the area of CAS₂, and some of the area of CAS₂ is not contained in CAS₁, and some of the area of CAS₁ is not contained in CAS₂.
   “Not-Overlapped”, each CAS shares no common area with the other CAS.
      E.g. The area of CAS₁, contains none of the area of CAS₂, and the area of CAS₂ contains none of the area of . . . CASₙ.
Each CAS₁ . . . CASₙ is assigned an attribute related to the extent by which the airspace is controlled:
   Monitored Flight Operations.
   Restricted Flight Operations.
   Prohibited Flight Operations.

As mentioned above, the definition of the controlled airspace(s) 24 may be referenced with respect to a fixed or stationary point for the stationary entity supporting V2I communications 30A of FIG. 3A. However, a reference point for defining the controlled airspace(s) 24 may change for a mobile entity supporting V2I communications 30B of FIG. 3B as the location of the mobile entity supporting V2I communications 30B changes during transit. Accordingly, the contents of the CAS definitions described above may change as location of the mobile entity supporting VCI communications changes.

IE 6-4: Flight Profile information element may comprise:
A sequence of one or more waypoints (X, Y and Z coordinates relate to Latitude, longitude and Altitude). A waypoint can be an intercept location (start of sequence), or an end location (end of sequence), or an intermediate location.
Target horizontal speed between each waypoint.
Target vertical speed between each waypoint.
Max deviation factor between each waypoint.
A Holding Pattern Profile. If set to TRUE, then after the VPU has acquired the last waypoint, the VPU will transit back to the first waypoint and restart the profile.

As in the case of controlled airspace(s), records and/or definitions such as flight profile records 170-1 may also change in view of the transit or movement of a mobile entity supporting V2I communications.

### 1.3.2 Structure: VPU Command Objects (VCO)

As illustrated in FIG. 7, a VPU Command Object (VCO) comprise various information elements (IEs) or fields, including but not limited to the following:

IE 7-1: An identify used to address the VPU that this VCO is for:
Global (or Default) ID
Group ID
VPU Unique ID

IE 7-2: Meta-data for this VCO
The unique ID for this VCO
Date and time stamp of when VCO was broadcast (i.e. RSU System Time)
Priority level

IE 7-3: VPU Commands. Examples of such VPU commands include the following:
Send Flight State Parameters
   [Airborne, Latitude, Longitude, Altitude, speed, direction, Operational flight time remaining]
Send Flight State Parameters when
   The VPU has completed a Flight Profile or Flight Commands
   The UAS has exited controlled airspace
Send UAS specific information
   [VPU Unique ID, UAS Unique ID]
   Mfg ID
   Device type
      [Helicopter∥Airplane∥Airship∥Other]
   Device capabilities
      [Min flight speed, Max flight speed, Empty weight, Max payload, Max flight time]
Send VPU configuration data (i.e. info about CADO's, VCO's and group ID)
   ID of the “Active CADO”
   ID of the “Active VCO”
   ID of all CADO's that are stored in VPU memory.
   The CADO Data Object identified by CADO Unique ID [xxx]
   The VCO Data Object identified by VCO Unique ID [zzz]
   Group ID(s)
Remove from VPU memory
   CADO Unique ID [xxx₀, xxx₁ . . . xxxₙ]
   VCO Unique ID [zzz]
   Group ID's [yyy₀, yyy₁ . . . yyyₙ]
Assign
   Group ID's [yyy₀, yyy₁ . . . yyyₙ] to this VPU
State
   Exit FCS Command Mode

IE 7-4: Other Data, such as (for example) Barometric pressure at the RSU (i.e. for altimeter corrections)

IE 7-5: Flight Commands, including by way of example:
Descend [to altitude XXX, rate of decent]
Ascend [to altitude YYY, rate of ascent]
Turn-Left [to heading XXX, rate of turn]
Turn-Right [to heading ZZZ, rate of turn]
Target horizontal speed
Target vertical speed
Any combinations of the above individual commands
   E.g. [Turn-Right [145 deg True, 3 deg/sec], Ascend [1000 ft, 200 ft/min] . . . ]
Execute FCS Emergency Decent Mode
Stop all propulsive mechanism and disable all fight control systems (i.e. crash)
Ignore all commands and data from the NPU.

### 1.3.3 Structure: Vehicle Data Object (VDO)

As illustrated in FIG. 8, a VPU Command Objects (VCO) comprise various information elements (IEs) or fields, including but not limited to the following:

IE 8-1: VDO meta data, including by way of example:
Meta-data for this VDO
   Unique ID for the VCO that triggered this VDO
   Message Sequence number for this VDO
Flight State Parameters
   [Airborne, Latitude, Longitude, Altitude, speed, direction, Operational flight time remaining]
UAS specific information
   [VPU Unique ID, UAS Unique ID]
   Mfg ID
   Device type
      [Helicopter∥Airplane Airship∥Other]
   Device capabilities
      [Min flight speed, Max flight speed, Empty weight, Max payload, Max flight time]

IE 8-2: VPU configuration data (i.e. info about CADO's, VCO's and Groups), such as (for example):
ID of the “Active CADO”
ID of the “Active VCO”
ID of all CADO's that are stored in VPU memory.
The CADO Data Object identified by CADO Unique ID [xxx]
The VCO Data Object identified by VCO Unique ID [zzz]
Group ID(s)

IE 8-3: VPU status, such as the following information (for example):
The VPU has started autonomous redirection of UAS to Monitored airspace.
The VPU is using autonomous redirection Method [a∥b∥c]
The VPU has stopped autonomous redirection of UAS to Monitored airspace.
The VPU has started executing Flight Commands from “VCO Unique ID”
The VPU has stopped executing Flight Commands from “VCO Unique ID”
The VPU has started executing Flight Profile from “CADO Unique ID”
The VPU has stopped executing Flight Profile from “CADO Unique ID”
The VPU has determined that is has
   Entered controlled airspace defined by
      CADO Unique ID [[1, [CAS₁ . . . CASₙ]], . . . [n,[CAS₁ . . . CASₙ]]]
   Exited controlled airspace defined by
      CADO Unique ID [[1,[CAS₁ . . . CASₙ]], . . . , [n,[CAS₁ . . . CASₙ]]]

### 2.0 Operation: Overview

As indicated above, the communications infrastructure 30 with its airspace controller 32 provides a geo-fencing system that is capable of adaptive and progressive levels of control authority over the unmanned aircraft system (UAS) e.g., drone 20. Such a system provides, e.g., a means for public safety operator to: uniquely identify the drone 20, take partial control over the drone 20 to prevent the drone 20 from approaching controlled airspace, take complete control over the drone 20 for the purpose of directing the drone 20 to a specific location via a specific route (i.e. a flight profile), and/or the disabling of the drone 20.

In operation the vehicle processing system (VPU) 54 may operate in any of several modes as described in Table 1 hereof, including but not limited to the following modes: FCS Open-Airspace Mode; FCS Monitored Mode; FCS Command Mode; FCS Restricted Mode; and FCS Prohibit Mode. Each of these modes is discussed briefly below, and more fully described in Table 1.

In the FCS Open-Airspace Mode, the VPU does not command the flight control system 50 to execute any Flight Commands, but the vehicle processing system (VPU) 54 may monitor from broadcasts from communications infrastructure (RSU) 30 for broadcasts.

In the FCS Monitored Mode the VPU does not command the flight control system 50 to execute any Flight Commands, but the vehicle processing system (VPU) 54 may monitor for communications infrastructure (RSU) 30 broadcasts and may, from time to time, broadcast a vehicle data message (VDO).

In the FCS Command Mode the vehicle processing system (VPU) 54 executes commands. The vehicle processing system (VPU) 54 will remain only in FCS Command Mode until it receives a subsequent VCO with the VPU Command to “Exit FCS Command Mode.

The flight state of the drone 20 may be either “non-airborne” or “airborne”. If the flight state of the drone 20 is “Non-airborne” and the FCS Restricted Mode is entered, then the VPU will enter into FCS Prohibit Mode (described below). On the other hand, if the he vehicle processing system (VPU) 54 determines that the flight state of the drone 20 is “airborne”, then the vehicle processing system (VPU) 54 may command the flight control system 50 in accordance with the content of the “Active CADO” and “Active CAS”, as described herein and in Table 1.

If the drone 20 enters into the FCS Prohibit Mode and the flight state is “non-airborne”, the vehicle processing system (VPU) 54 will command the flight control system 50 to disable all flight control surfaces and propulsion mechanisms. The vehicle processing system (VPU) 54 will remain in the prohibit mode until the vehicle processing system (VPU) 54 is Power-cycled, and the system reboots (e.g. the device is power cycled). On the other hand, if the flight state of the drone 20 is “airborne”, then the vehicle processing system (VPU) 54 may command the flight control system 50 in accordance with the content of the “Active CADO” and “Active CAS”, as described herein and in Table 1.

### 2.1 Operation: Communications System (V2I System)

The communications system (V2I system) 56 is configured to transmit information to the communications infrastructure (RSU) 30 (e.g. UAS identification response). In an example embodiment and mode the communications system (V2I system) 56 is non-network controlled and not reliant on the resources of a commercial network. However, the communications system (V2I system) 56 is not precluded from using the resources of a commercial network and coordinated with said network for use of its resources. In an example embodiment and mode communications system (V2I system) 56 may receive data transmitted by the communications infrastructure (RSU) 30.

As indicated above, in example embodiments and modes communications system (V2I system) 56 is responsible for receiving information transmitted by the communications infrastructure (RSU) 30 (e.g., Controlled Area Data Objects (CADO) and VPU Command Objects (VCO)), and for transmitting Vehicle Data Objects (VDO) to the communications infrastructure (RSU) 30.

### 2.2 Operation: Flight Control System (FCS)

The flight control system (FCS) 50 is responsible for the aggregation of flight commands, sensor data, feed-back of control loops, and the execution of appropriate stimulus to the flight control surfaces to effect the intended flight path of the UAS per the flight commands. Flight commands may come from the native processing system (NPU) 52 or the vehicle processing system (VPU) 54.

The flight control system (FCS) 50 comprises FCS interface 74 to abstract the FCS's operation of the flight control surfaces from the flight commands received from the vehicle processing system (VPU) 54 or native processing system (NPU) 52. For example if the UAS is of type “Helicopter”, then a flight command from the VPU to “Descend” may be interpreted by the flight control system (FCS) 50, along with other data, to decrease the rotor speed to effect a descent of the drone 20. Thus the abstraction allows the native processing system (NPU) 52 to interface with the flight control system (FCS) 50 at a level related to commands for a change in flight state, while the technical aspects necessary to execute the command (as it relates to inputs to the flight control surface) is encapsulated in the flight control system (FCS) 50.

### 2.2.1 Operation: Flight Commands

Example flight command that the flight control system (FCS) 50 may accept as input may include the following:
Descend [to altitude XXX, rate of decent]
Ascend [to altitude YYY, rate of ascent]
Turn Left [to heading XXX, rate of turn]
Turn Right [to heading ZZZ, rate of turn]
Target horizontal speed
Target vertical speed
Combination of the above (Ascend and turn right at speed x)
Execute FCS Emergency Decent Mode
Stop all propulsive mechanism and disable all fight control systems (i.e. crash)
Ignore all commands and data from the native processing system (NPU) 52.

### 2.2.2 Operation: Flight Descent Mode

In example embodiments and modes flight control system (FCS) 50 may comprise or execute a pre-configured flight profile known as “Emergency Descent Mode” (see emergency descent mode logic 78 in FIG. 4). When triggered, this emergency descent mode logic 78 causes the flight control system (FCS) 50 to execute a set of commands that will result in the drone 20 to
stabilize aircraft to horizontal flight,
stabilize aircraft to constant heading,
adjust flight speed to minimum controllable airspeed, and then
execute a decent at minimum controllable airspeed with minimum propulsion power settings.

The flight control system (FCS) 50 will continue the decent and power settings until the drone 20 stops descending (e.g., lands/crashes). The flight control system (FCS) 50 will then disable all propulsion and flight control surfaces.

### 2.3 Operation: Flight Control System Encryption/Authentication

In example embodiments and modes flight control system (FCS) 50 comprises message authentication mode logic 76, and accordingly the flight control system (FCS) 50 may employ authentication and/or cryptographic procedures (i.e., Message Authentication Code (MAC)) to authenticate the flight commands from the vehicle processing system (VPU) 54. The flight control system (FCS) 50 may periodically query the vehicle processing system (VPU) 54 to determine the operational status of the vehicle processing system (VPU) 54. If the flight control system (FCS) 50 cannot authenticate the flight commands, or the FCS does not receive a response from the VPU after sending a status query to it, the FCS will either execute its “Emergency Decent Mode” if available, or it will disable all propulsion and flight control surfaces (i.e., if in flight, the UAS will crash).

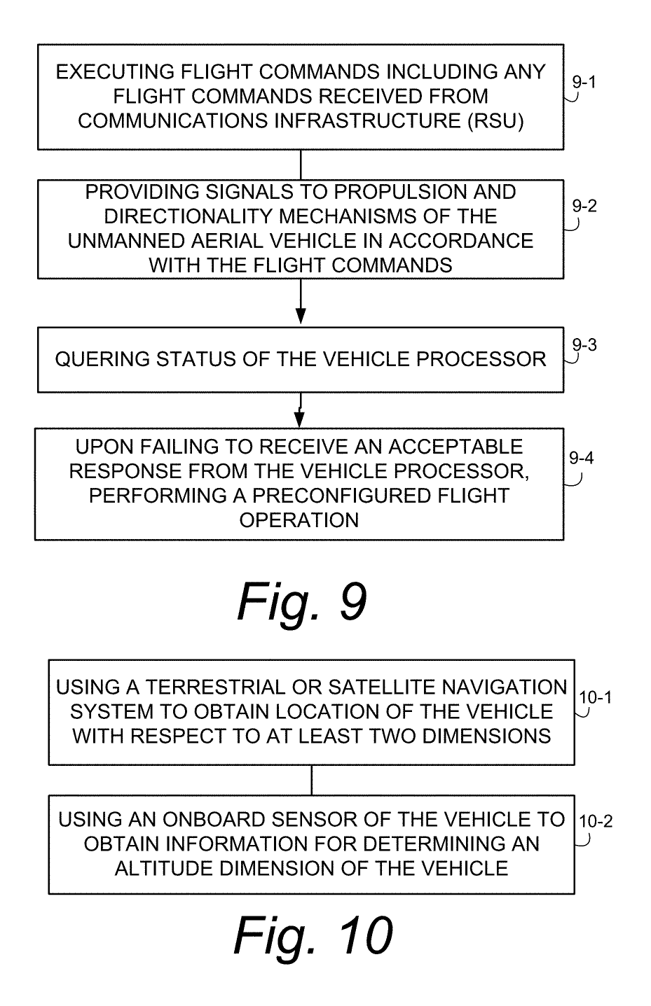

FIG. 9 illustrates example, basic acts or steps comprising executed by processor circuitry 70 of drone 20, and (for at least some example embodiments and modes) the flight control system (FCS) 50. Act 9-1 comprises using a vehicle processor (e.g., vehicle processing system (VPU) 54) to execute flight commands including any flight commands received from an entity supporting V2I communications (e.g., communications infrastructure (RSU) 30) via communications circuitry (e.g., communications system (V2I system) 56) configured to participate in vehicle-to-infrastructure (V2I) communications with the entity supporting V2I communications. Act 9-2 comprises using a flight controller (e.g., flight control system (FCS) 50) to provide signals to propulsion and directionality mechanisms of the unmanned aerial vehicle in accordance with the flight commands. Act 9-3 comprises using the flight controller (e.g., flight control system (FCS) 50) to query status of the vehicle processor. Act 9-3 comprises, upon failing to receive an acceptable response from the vehicle processor, using the flight controller (e.g., flight control system (FCS) 50) to perform a preconfigured flight operation. The preconfigured flight operation may be, for example, the emergency descent mode logic 78 described in section 2.2.2 above.

### 2.4 Operation: Location Determination

The drone location determination unit (DLU) 64 is responsible for the aggregation and processing of data that results in spatial, speed and direction data provided to the vehicle processing system (VPU) 54. Using time and date acquisition unit 67 the drone location determination unit (DLU) 64 may also provide system date and time to the vehicle processing system (VPU) 5. In some example embodiments and modes, the time and date acquisition unit 67 of location determination unit (LDU) 64 may obtain system data and time (as well as location) from GNSS unit 68. The GNSS unit 68 broadcasts system date and time in Coordinated Universal Time (UTC). In other example embodiments and modes, the time and date acquisition unit 67 of location determination unit (LDU) 64 may obtain date and time from communications infrastructure (RSU) 30. In this regard, the communications infrastructure (RSU) 30 may stamp each object transmitted by the communications infrastructure (RSU) 30, e.g., CADO and VCO objects, with the UTC when the objects are transmitted from the communications infrastructure (RSU) 30 to the communications system (V2I system) 56 of drone 20. The vehicle processing system (VPU) 54 may forward the data obtained from the drone location determination unit (DLU) 64 to the flight control system (FCS) 50.

In example embodiments and modes the drone location determination unit (DLU) 64 may obtain (via the vehicle processing system (VPU) 54) location information, system time and date from a GNSS receiver or other terrestrial systems. There are presently at least 4 GNSS systems operational: GPS, GLONASS, Galileo or Beido. Some advanced receivers may receive and process the singles from multiple GNSS systems to provide redundancy and/or accuracy. Terrestrial systems used by the drone location determination unit (DLU) 64 to provide location data in two dimensions may be Loran, eLoran, LTE OTDOA, or Cellular U-TDOA. In some example embodiments and modes, the spatial output of the drone location determination unit (DLU) 64 is in three dimensions that represent latitude, longitude, and altitude. The NextNav system is reported to provide a results in three dimensions.

### 2.4.1 Operation: Onboard Sensor for Altitute Location Determination

In some example embodiments and modes the drone location determination unit (DLU) 64, may only be able to resolve a location in two dimensions (i.e., only latitude and longitude) due, e.g., to the limitation of some terrestrial systems, or the GNSS may not be able to resolve an altitude coordinate (e.g. due to poor RF conditions). In some such example embodiments and modes the altitude coordinate may be determined, and a spatial position resolved, by the use of either pressure altimeter, radar altimeter or accelerometer sensors that may be integrated into the drone 20.

In the above regard, FIG. 10 illustrates example, representative acts or steps which may be performed by drone location determination unit (DLU) 64. Act 10-1 comprises using a terrestrial or satellite navigation system to obtain location of the vehicle with respect to at least two dimensions. Act 10-2 comprises using an onboard sensor of the vehicle to obtain information for determining an altitude dimension of the vehicle. The information provided by onboard sensor may not be the altitude per se, but may be an input upon which determination of the altitude is dependent, as explained below.

If a pressure altimeter is used to determine an altitude coordinate, then a correction may be applied per a current local barometric pressure data object which is sent by communications infrastructure (RSU) 30 via a VPU Command Object (VCO). Using, e.g., VPU cryptographic unit 86, the vehicle processing system (VPU) 54 may employ cryptographic procedures (i.e. Message Authentication Code (MAC)) to authenticate the data received from the drone location determination unit (DLU) 64. Thus, when the location determination unit (LDU) 64 uses the onboard altitude sensor to provide the 3rd dimension, the value received from the pressure sensor may not be accurate as it needs to be corrected for the current barometric pressure, which changes with the weather. For that reason the communications infrastructure (RSU) 30 sends in a VCO the current barometric pressure at the communications infrastructure (RSU) 30. As the communications infrastructure (RSU) 30 is on the ground and likely knows its altitude and the current barometric pressure, the communications infrastructure (RSU) 30 can calculate the correction factor, or it can get it from a nearby airport.

Thus, the drone location determination unit (DLU) 64, which comprises processor circuitry 70, may be considered a vehicle location determination processor configured to determine location of the vehicle with respect to three dimensions, wherein location of the vehicle with respect to at least two of the dimensions is obtained using a terrestrial or satellite navigation system (e.g., GNSS), and wherein one of the three dimension is an altitude dimension, and wherein the altitude dimension is obtained from an onboard sensor of the vehicle (e.g., one of the drone sensors 62, such as drone altimeter 66). Other altitude-obtaining instruments which may be included in the onboard drone sensors 62 comprise: Radar Altimeter, Laser Range Finder, Acoustic Range Finder, and, an Optical Range Finder.

### 2.4.2 Operation: Location Determination Failure

In example embodiments and modes the vehicle processing system (VPU) 54 may command the drone location determination unit (DLU) 64 to provide the location of the drone 20. If the vehicle processing system (VPU) 54 cannot obtain spatial location information from the drone location determination unit (DLU) 64, then in some example implementations the vehicle processing system (VPU) 54 may inter into FCS Prohibit Mode. On the other hand, if the vehicle processing system (VPU) 54 can obtain location information in 3D, then the vehicle processing system (VPU) 54 may operate normally.

### 2.5 Operation: Authentication of Interactions

In example embodiments and modes the vehicle processing system (VPU) 54 may communicate via a dedicated interface to the communications system (V2I system) 56, to the flight control system (FCS) 50, and to the drone location determination unit (DLU) 64. Examples of such dedicated interfaces include interfaces 90 and 92 shown in FIG. 4. In example embodiments and modes, information exchanged between the vehicle processing system (VPU) 54, communications system (V2I system) 56, flight control system (FCS) 50, and drone location determination unit (DLU) 64 may employ cryptographic procedures (i.e. Message Authentication Code (MAC)) to authenticate the data received from those devices. The vehicle processing system (VPU) 54 may communicate via a dedicated interface to GNSS, Radar Altimeter, Laser Range Finder, Acoustic Range Finder, Optical Range Finder, Accelerometers, Pressure Altimeter, Magnetic, Thermal, Electrical, and Proximity and other sensors that are native to the UAS. The information exchanged between the vehicle processing system (VPU) 54 and such sensors 62 may employ cryptographic procedures (i.e. Message Authentication Code (MAC)) to authenticate the data received from those devices

Thus, in example embodiments and modes, the technology disclosed herein includes a flight controller (e.g., flight control system (FCS) 50) configured to provide signals to a propulsion mechanism and/or a directionality mechanism of the vehicle in accordance with at least one of native flight commands and vehicle processor command. The communications circuitry (e.g., communications system (V2I system) 56) is configured to participate in vehicle-to-infrastructure (V2I) communications with an entity supporting V2I communications (e.g., communications infrastructure (RSU) 30) and to receive infrastructure flight commands therefrom. The vehicle processing system (VPU) 54 is configured to engage in a first interaction with the communications circuitry and thereby possibly obtain any infrastructure flight commands received from the entity supporting V2I communications (e.g., communications infrastructure (RSU) 30) and to engage in a second interaction with the flight controller (e.g., flight control system (FCS) 50) on the basis of vehicle processor flight commands including any infrastructure flight commands received from the entity supporting V2I communications. The technology disclosed herein further comprises an authentication processor configured to authenticate at least one of the first interaction and the second interaction. As understood from the foregoing and as illustrated in FIG. 4, the authentication processor includes processor circuitry 70 and its functionalities message authentication mode logic 76, VPU cryptographic unit 86, and V2I cryptographic unit 142, for example. Further, one or more of drone location determination unit (DLU) 64 and drone sensors 62 may engage in a third interaction with at least one of the flight controller 50 and the vehicle processor 54, and in such implementation the authentication processor is configured to authenticate at least one of the first interaction, the second interaction, and the third interaction.

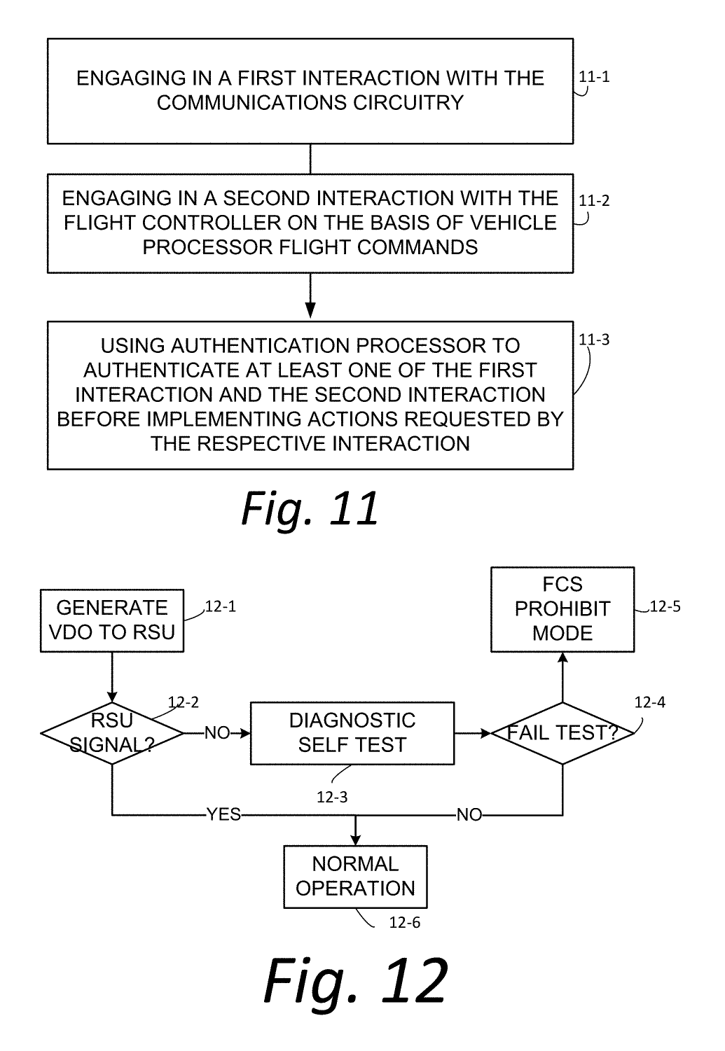

FIG. 11 illustrates example, representative acts or steps comprising an authentication procedure of the technology disclosed herein. Act 11-1 comprises vehicle processor 54 engaging in a first interaction with the communications circuitry 56 and obtaining any infrastructure flight commands received from the entity supporting V2I communications. Act 11-2 comprises the vehicle processor 54 engaging in a second interaction with the flight controller 50 on the basis of vehicle processor flight commands, including flight commands generated by vehicle processing system (VPU) 54 and/or any infrastructure flight commands received from the entity supporting V2I communication (e.g., from communications infrastructure (RSU) 30). Act 11-3 comprises using the authentication processor to authenticate at least one of the first interaction and the second interaction before implementing actions requested by the respective interaction.

### 2.6 Operation: Fault Detection/Self-Testing

In example embodiments and modes which perform example acts or steps illustrated in FIG. 12, as act 12-1 the vehicle processing system (VPU) 54 may generate one or more Vehicle Data Object (VDO) messages to transmit to the communications infrastructure (RSU) 30 (via the communications system (V2I system) 56). As act 12-2, the vehicle processing system (VPU) 54 may command the communications system (V2I system) 56 to attempt to receive messages broadcasted from the communications infrastructure (RSU) 30.

If the communications system (V2I system) 56 device reports to the vehicle processing system (VPU) 54 that it cannot receive any signal from a communications infrastructure (RSU) 30 (as indicated by the negative branch from act 12-2), then as act 12-3 the vehicle processing system (VPU) 54 may command the communications system (V2I system) 56 device to perform diagnostic self-tests and report the results of the tests to the vehicle processing system (VPU) 54. The self-test may be performed by self-test functionality 143 of drone communication fault detection controller 58, as shown in FIG. 4. If it is determined as act 12-4 that the communications system (V2I system) 56 fails the self-test, then the VPU may enter a “FCS Prohibit mode” as indicated by act 12-5. If the communications system (V2I system) 56 reports that it is operating per specification, then the vehicle processing system (VPU) 54 may operate normally (as indicated by act 12-6).

Thus, communications system (V2I system) 56 device may be commanded by the vehicle processing system (VPU) 54 to execute a self-test and report the results back to the vehicle processing system (VPU) 54. To this end communications system (V2I system) 56 includes the self-test functionality 143 shown in FIG. 4. The self-test performed by self-test functionality 143 may include, for example, a Voltage Standing Wave Ratio (VSWR) to determine if the antenna 57 is functioning per specification. In the self-test the communications system (V2I system) 56 device may attempt to receive and decode any LTE signal. The communications system (V2I system) 56 device may measure a SINR, RSRP, RSSI and RSRQ of the side-link channel(s) or Uu channel to determine if the link is being interfered with (e.g. A RSRP level GT −75 may indicate a jamming, while −75 to −120 is normal). Thus, if a failed or corrupted link is detected, the processor may disable all flight functions of the vehicle. For example, if the communication link has been sabotaged on the vehicle, the vehicle should not fly. However, it should be taken into account that, if the vehicle is operating is such a remote area that there is no signal from an RSU to verify the communication link, the vehicle flight functions should not be disabled.

Thus, as described above, the vehicle processing system (VPU) 54 may be configured to detect interference on the link between the vehicle and the stationary entity supporting V2I communications. “Detecting interference” may be the same as the physical layer or the medium access control (MAC) layer not being able to decode the channel. If the physical layer or MAC layer cannot decode the channel it may be due to interference (natural and/or man-made) or it may be due to insufficient signal. Either case may appear the same to the receiver, but in in the case of strong man-made interference there may be poor SINR.

The vehicle processing system (VPU) 54 may be configured to detect a virus which has been inserted into, e.g., infected, the software of the vehicle to cause improper operation. The virus check/detection may be done via a CRC check or a MAC or a HASH of the ROM and RAM (assuming an EEPROM is used). This security check could occur periodically or at each power-on. For example, if the virus is able to corrupt any element in 88-1 through 88-7, then the memory manager in 84 should be able to detect it, if upon each change that the memory manager makes to RAM it computes a new CRC, etc., and at some later time does a check on that RAM and compares it to the stored CRC that was calculated at last time the VPU memory manager 84 made a change to the RAM. A ROM check may be done by the memory manager 84 also, but the memory manager 84 does not update the firm-ware (at least not in an example implementation) so it only checks the most recent CRC calculation against the CRC that was calculated and stored into ROM at time of manufacturer.

The vehicle processing system (VPU) 54 may be configured to detect a fault in random access memory (RAM) or read only memory (ROM), e.g., of the vehicle processing system (VPU) 54.

### 2.7 Operation: Vehicle Processing System (VPU): Overview

The vehicle processing system (VPU) 54 is responsible for:
Processing data and commands obtained from a Controlled Area Data Object (CADO).
Processing data and commands obtained from a VPU Command Object (VCO).
Processing data and commands received from the drone location determination unit (DLU) 64.
Processing data and commands received from the flight control system (FCS) 50.
Processing data from onboard sensors (e.g., GNSS, Radar Altimeter, Laser Range Finder, Acoustic Range Finder, Optical Range Finder, Accelerometers, Pressure Altimeter, Magnetic, Thermal, Electrical, and Proximity) and forwarding data to other devices (e.g. the LDU)
Generation of Flight Commands to be sent to the flight control system (FCS) 50.
Forwarding of Flight Commands from a VPU Command Object (VCO) to the flight control system (FCS) 50.

The vehicle processing system (VPU) 54 may collate, interpret and act upon data and commands related to the interaction of the drone 20 and an area of controlled airspace (e.g., controlled airspace 24). Such data may be obtained from sensors 62 situated onboard the drone 20 (e.g., GNSS 68), from a Controlled Area Data Object (CADO) (e.g., definition of controlled airspace) and from a VPU Command Object (VCO) (e.g., local pressure altimeter setting). Such commands may be obtained from a VPU Command Object (VCO) (e.g., send a Vehicle Data Object (VDO)) and from a Controlled Area Data Object (CADO) (e.g., Flight Profile).

The vehicle processing system (VPU) 54 may be integrated into the flight control system (FCS) 50, which is native to the drone 20, as a means to execute control over the flight operations of the drone 20. The vehicle processing system (VPU) 54 may be integrated into the flight control system (FCS) 50 to the same level as the native processing system (NPU) 52 that is normally used to control the drone 20 via the native RF device. The vehicle processing system (VPU) 54 may command the flight control system (FCS) 50 to execute a flight profile and/or flight commands. The vehicle processing system (VPU) 54 may command the flight control system (FCS) 50 to ignore any commands/data from the native processing system (NPU) 52 (i.e., commands and data that originate from the native RF device or native data port, or pre-programed into the native device).

As described above, the vehicle processing system (VPU) 54 may use as system time and date value obtained from the drone location determination unit (DLU) 64 or from the communications infrastructure (RSU) 30. System Time and Date may be used by the vehicle processing system (VPU) 54 to manage data stored in the vehicle processing system (VPU) 54, such as determining the expiration of a Controlled Area Data Object (CADO).

In example embodiments and modes the vehicle processing system (VPU) 54 is configured at time of manufacture with a VPU Unique ID and a Global ID. The vehicle processing system (VPU) 54 may be pre-configured at time of manufacture or at time of provisioning, or by reception of a VPU Command Object (VCO), with one or more Group ID's.

### 2.7.1 Operation: Vehicle Processing System (VPU): CADO

The vehicle processing system (VPU) 54 may receive (via the communications system (V2I system) 56) a Controlled Area Data Object (CADO) that was transmitted by the RSU. The vehicle processing system (VPU) 54 may be pre-configured with one or more Controlled Area Data Objects (CADO) at time of manufacture, or at time of provisioning. In terms of Controlled Area Data Object (CADO) use by the vehicle processing system (VPU) 54:
A CADO is associated to the VPU via a Global ID, or Group ID or VPU Unique ID.
The CADO may be stored into the VPU memory.
   The VPU may remove a CADO from memory once it has expired.
   The VPU may remove a CADO from memory via command in a VCO.

### 2.7.2 Operation: Vehicle Processing System (VPU): VCO

The vehicle processing system (VPU) 54 may receive (via the V2I) a VPU Command Object (VCO) that was transmitted by the communications infrastructure (RSU) 30. Regarding VPU Command Object (VCO) use by the vehicle processing system (VPU) 54:
The VCO may be associated to the VPU via Global ID, Group ID or VPU Unique ID.
The VCO may be stored into the VPU memory.
   A VCO is a temporal data object, and is retained by the VPU until all the Flight Commands and/or VPU Commands are executed.
The VCO may contain a “VPU Command” data object.
   The VPU Command may request the VPU to send a VDO that contains UAS and VPU information back to the RSU.
   The VPU Command may request the VPU to remove a specific CADO from memory. If the priority level of the VCO message is grater then the identified CADO, then the VPU will remove that CADO from memory. If the removed CADO is the “Active CADO”, then the VPU will consider all CADO's in memory and identify a new “Active CADO” and new “Active CAS”.
   The VPU Command may request the VPU to remove a specific VCO from memory. If the priority level of the VCO message is grater then the identified VCO, then the VPU will remove that VCO from memory.
   The VPU Command may request the VPU to add/remove a Group ID.
   The VPU Command may request the VPU to change its internal operating state such that it exits the “FCS Command Mode” and returns to normal operating mode.
   VPU commands are executed by the VPU at its first opportunity, and thus are not synchronized in time with Flight Commands
The VCO may contain a “Flight Command” data object.
   The received Flight Command data object may trigger the VPU to enter into “FCS Command Mode”
   The received Flight Command data object may contain an individual flight command (i.e. Turn left). Or it may contain a sequence of flight commands (i.e. Turn right and descend), which the VPU may execute, one-by-one and in order.

### 2.7.3 Operation: Vehicle Processing System (VPU): VDO

The vehicle processing system (VPU) 54 may from time to time transmit (via the communications system (V2I system) 56) a Vehicle Data Object (VDO) to any communications infrastructure (RSU) 30 that may receive it (e.g., a broadcast). The Vehicle Data Object (VDO) may comprise the VPU Unique ID, which is known by the communications infrastructure (RSU) 30, and the communications infrastructure (RSU) 30 may then send a VCO and CADO to the vehicle processing system (VPU) 54 configured such that the drone 20 is allowed access to airspace that would otherwise be restricted or prohibited.

### 2.7.4 Operation: Vehicle Processing System (VPU): Processing Loop

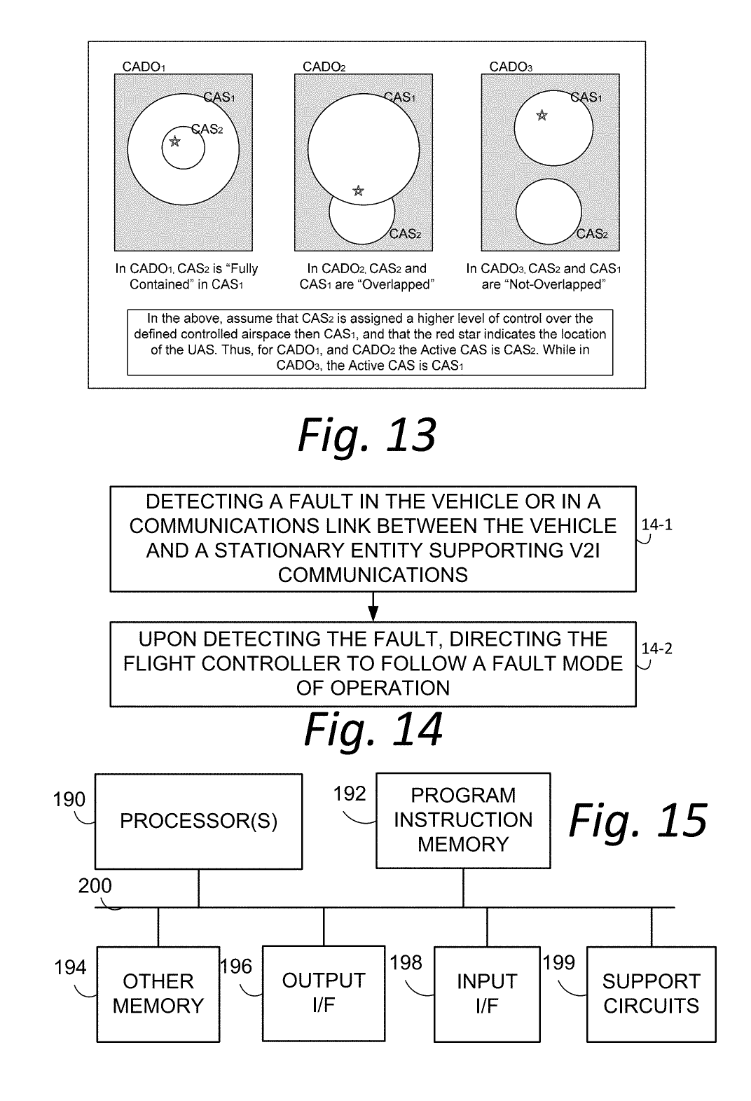

Table 1 shows example acts or steps that may be performed by vehicle processing system (VPU) 54 in example embodiments and modes. Table 1 refers to controller airspace (CAS), and in some instances to plural controlled airspaces (CAS₁, CAS₂, etc.). FIG. 13 is a diagrammatic view illustrating differing relationships—“contained in”, “overlapped”, and “not overlapped”—of plural controlled airspaces.

### 2.8 Operation: General Recap

FIG. 14 shows various non-limiting example, basic acts or steps that may be executed by the unmanned air vehicle in accordance with an example embodiment and mode of the technology disclosed herein, and as understood from aspects and features described above. Act 14-1 comprises detecting a fault in the vehicle or in a communications link between the vehicle and an entity supporting V2I communications. Act 14-2 comprises, upon detecting the fault, directing the flight controller to follow a fault mode of operation for overriding propulsion and directionality of the unmanned aerial vehicle. As understood from the foregoing, act 14-1 may comprise, e.g., detecting inoperability of the communications circuitry or detecting interference on the link between the vehicle and the entity supporting V2I communications. Moreover, in an example embodiment and mode, act 14-1 may comprise directing communications circuitry to receive flight commands between vehicle and the entity supporting V2I communications and, upon inability to receive the flight commands, as act 14-2 directing the flight controller to follow the default mode. The fault mode of operation may be a non-flight mode of operation of the unmanned aerial vehicle, or a descent mode of operation.

### 3.0 Example Advantages and Features

The technology disclosed herein thus encompasses but is not limited to the following example features, advantages, and attributes:

A system that precludes access to controlled airspace by un-authorized UAS, e.g., drones.

A system that allows access to controlled airspace for authorized drones.

A system that has progressive levels of control over drones, based on the location of the drone relative to the controlled airspace, current flight status of the drone, the configuration of the drone, and the configuration of the system.

A system that can be configured and modified as needed in real-time.

A system that can be operated in an autonomous mode, semi-autonomous mode or directly control mode.

A system that provides secure communications between key components. (i.e. end-to-end confidentiality and integrity of data and signaling between the logical components of the system)

A system that provided fault detection on key components. (i.e. end-to-end operation of the communication link from VPU to the RSU)

A system that provides alternate methods for determining an altitude coordinate.

A system and process that provides an alternate means to determine the altitude coordinate in a spatial location tuple when latitude and longitude are provided by GNSS. If a valid spatial coordinate set cannot be resolved, then a change in state of the UAS to a non-flight mode. As used herein, in a “non-flight mode” the vehicle, if not in flight, is not permitted to thereafter fly when in non-flight mode. If the vehicle is in flight, upon entering the “non-flight mode” the vehicle is commanded to descend or follow other instructions to ground the vehicle, or directed to crash.

A system that can be deployed on demand, and independently of any operators network (i.e. There is no need to confer, coordinate or interface with a local commercial network operator for the use of their system resources (i.e. RF, eNB, CN, etc.)). Examples of where such a system is employed: Disaster Area, and Large Public Gathering.

A system that employ schemes to ensure that the operation of systems and devices (V2I, VPU, FCS, and LDU) as integrated into the UAS are not tampered with, removed or otherwise precluded from its normal and intended operation.

A system that employ schemes to ensure the security of the communication between the components of the system (V2I, VPU, FCS, and LDU) as integrated into the drone.

A system that facilitates detection by the VPU that the V2I antenna is disabled or removed, resulting in a change in state of the UAS to a non-flight mode.

A system that facilitates detection by the VPU that that the V2I is not functioning, resulting is a change in state of the UAS to a non-flight mode.

A system that facilitates detection by the FCS that that the VPU is not functioning, resulting is a change in state of the UAS to a non-flight mode.

A system that employ schemes to ensure the security of the information broadcast by a communications infrastructure (RSU) 30.

### 4.0 Computer/Processor Implementations

Certain units and functionalities of drone 20 and communications infrastructure (RSU) 30, framed by broken or dotted lines are, in example embodiments and modes, implemented by electronic machinery such as is shown in FIG. 15. FIG. 15 shows an example of such electronic machinery or processor circuitry as comprising one or more processors 190, program instruction memory 192; other memory 194 (e.g., RAM, cache, etc.); input/output interfaces 196; peripheral interfaces 198; support circuits 199; and busses 200 for communication between the aforementioned units. The processor(s) 190 may comprise the processor circuitry 70 of FIG. 4, the V2I processor 122 of FIG. 4, or the RSU processor circuitry 152 of FIG. 5, for example.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise any of the memories described herein. The support circuits 199 are coupled to the processors 190 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein and message rate control algorithm 80 particularly may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 40 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

The technology disclosed herein thus encompasses the following non-exhaustive example embodiment and modes:

Example Embodiment 1: An unmanned aerial vehicle comprising:

a flight controller configured to provide signals to propulsion and directionality mechanisms of the unmanned aerial vehicle;

communications circuitry configured to participate in vehicle-to-infrastructure (V2I) communications with an entity supporting V2I communications, the communications circuitry comprising:

transceiver circuitry comprising an antenna configured to transceiver wireless signals of the V2I communications; and

processor circuitry configured:
to detect a fault in the V2I communications circuitry; and
upon detecting the fault, to direct the flight controller to follow a fault mode of operation for overriding propulsion and directionality of the unmanned aerial vehicle.

Example Embodiment 2. The apparatus of Example Embodiment 1, wherein the processor circuitry is configured to detect inoperability of the communications circuitry.

Example Embodiment 3. The apparatus of Example Embodiment 1, wherein the processor circuitry is configured to detect removal or inoperability of the antenna.

Example Embodiment 4. The apparatus of Example Embodiment 1, wherein the fault mode of operation is a non-flight mode of operation of the unmanned aerial vehicle.

Example Embodiment 5. A method in an unmanned aerial vehicle comprising:

a flight controller providing signals to propulsion and directionality mechanisms of the unmanned aerial vehicle;

detecting a fault in V2I communications circuitry configured to participate in vehicle-to-infrastructure (V2I) communications with an entity supporting V2I communications; and

upon detecting the fault, directing the flight controller to follow a fault mode of operation for overriding propulsion and directionality of the unmanned aerial vehicle.

Example Embodiment 6. The method of Example Embodiment 5, wherein the fault is inoperability of the communications circuitry.

Example Embodiment 7. The method of Example Embodiment 5, wherein the fault is removal or inoperability of the antenna.

Example Embodiment 8. The method of Example Embodiment 5, wherein the fault mode of operation is a non-flight mode of operation of the unmanned aerial vehicle.

Example Embodiment 9. An unmanned aerial vehicle comprising:

communications circuitry configured to participate in vehicle-to-infrastructure (V2I) communications with an entity supporting V2I communications,

a vehicle processor configured to execute flight commands including any flight commands received via the communications circuitry from the entity supporting V2I communications;

a flight controller configured to:
provide signals to propulsion and directionality mechanisms of the unmanned aerial vehicle in accordance with the flight commands;
query status of the vehicle processor and, upon failing to receive an acceptable response from the vehicle processor, to perform a preconfigured flight operation.

Example Embodiment 10. The apparatus of Example Embodiment 9, wherein the flight controller is configured to authenticate flight commands of the vehicle processor and upon failing to authenticate the flight commands to perform the preconfigured flight operation.

Example Embodiment 11. The apparatus of Example Embodiment 9, wherein preconfigured flight operation comprises a descent mode operation.

Example Embodiment 12. A method in an unmanned aerial vehicle comprising:

using a vehicle processor to execute flight commands including any flight commands received from an entity supporting V2I communications via communications circuitry configured to participate in vehicle-to-infrastructure (V2I) communications with the entity supporting V2I communications

using a flight controller to:
provide signals to propulsion and directionality mechanisms of the unmanned aerial vehicle in accordance with the flight commands;
query status of the vehicle processor and, upon failing to receive an acceptable response from the vehicle processor, to perform a preconfigured flight operation.

Example Embodiment 13. The method of Example Embodiment 12, further comprising using the flight controller to authenticate flight commands of the vehicle processor, and wherein upon failing to authenticate the flight commands to perform the preconfigured flight operation.

Example Embodiment 14. An unmanned aerial vehicle comprising:

a fuselage;

a propulsion mechanism and a directionality mechanism mounted on the fuselage;

a flight controller configured to provide signals to the propulsion mechanisms and/or the directionality mechanism;

a vehicle location determination processor configured to determine location of the vehicle with respect to three dimensions, wherein location of the vehicle with respect to at least two of the dimensions is obtained using a terrestrial or satellite navigation system, and wherein one of the three dimension is an altitude dimension, and wherein the altitude dimension is dependent upon information obtained from an onboard sensor of the vehicle.

Example Embodiment 15. A method in an unmanned aerial vehicle comprising:

using a terrestrial or satellite navigation system to obtain location of the vehicle with respect to at least two dimensions;

using an onboard sensor of the vehicle to obtain information for determining an altitude dimension of the vehicle.

Example Embodiment 16. An unmanned aerial vehicle comprising:

a flight controller configured to provide signals to a propulsion mechanism and/or a directionality mechanism of the vehicle in accordance with at least one of native flight commands and vehicle processor commands;

communications circuitry configured to participate in vehicle-to-infrastructure (V2I) communications with an entity supporting V2I communications and to receive infrastructure flight commands therefrom;

a vehicle processor configured:
to engage in a first interaction with the communications circuitry and to obtain any infrastructure flight commands received from the entity supporting V2I communications;
to engage in a second interaction with the flight controller on the basis of vehicle processor flight commands including any infrastructure flight commands received from the entity supporting V2I communications;

an authentication processor configured to authenticate at least one of the first interaction and the second interaction.

Example Embodiment 17. The apparatus of Example Embodiment 16, further comprising a location determination unit (DLU) which engages in a third interaction with at least one of the flight controller and the vehicle processor, and wherein the authentication processor configured to authenticate at least one of the first interaction, the second interaction, and the third interaction.

Example Embodiment 18. A method in an unmanned aerial vehicle comprising:

a vehicle processor engaging in a first interaction with the communications circuitry and to obtain any infrastructure flight commands received from the entity supporting V2I communications;

a vehicle processor engaging in a second interaction with the flight controller on the basis of vehicle processor flight commands including any infrastructure flight commands received from the entity supporting V2I communications;

using an authentication processor to authenticate at least one of the first interaction and the second interaction before implementing actions requested by the respective interaction.

Example Embodiment 19. The method of Example Embodiment 18, further comprising a location determination unit (DLU) engaging in a third interaction with at least one of the flight controller and the vehicle processor, and further comprising using the authentication processor to authenticate at least one of the first interaction, the second interaction, and the third interaction.

Example Embodiment 20. An unmanned aerial vehicle comprising:

a flight controller configured to provide signals to propulsion and directionality mechanisms of the unmanned aerial vehicle;

communications circuitry configured to participate in vehicle-to-infrastructure (V2I) communications with an entity supporting V2I communications;

transceiver circuitry comprising an antenna configured to transceive wireless signals of the V2I communications; and

processor circuitry configured:
to detect a fault in the vehicle or in a communications link between the vehicle and the entity supporting V2I communications; and
upon detecting the fault, to direct the flight controller to follow a fault mode of operation for overriding propulsion and directionality of the unmanned aerial vehicle.

Example Embodiment 21. The apparatus of Example Embodiment 20, wherein the processor circuitry is configured to perform a check of the communications circuitry to detect the fault.

Example Embodiment 22. The apparatus of claim Example Embodiment 20, wherein the processor circuitry is configured to detect one or more of the following:

removal or inoperability of the antenna;

interference on the link between the vehicle and the entity supporting V2I communications; and

a fault in random access memory (RAM) and/or read only memory (ROM) associated with the processor circuitry;

a virus inserted into software executed by the processor circuitry.

Example Embodiment 23. The apparatus of Example Embodiment 20, wherein the processor is configured to command the communications circuitry to receive flight commands between vehicle and entity supporting V2I communications and, upon inability to receive the flight commands, to direct the flight controller to follow the default mode.

Example Embodiment 24. The apparatus of Example Embodiment 23, wherein the fault mode of operation comprises one or more of the following:

a non-flight mode of operation of the unmanned aerial vehicle;

a descent mode of operation of the unmanned aerial vehicle; and

disablement of propulsion and directionality mechanisms of the unmanned aerial vehicle.

Example Embodiment 25. The unmanned aerial vehicle of Example Embodiment 20, further comprising:

a vehicle processor configured to execute flight commands including any flight commands received via the communications circuitry from the entity supporting V2I communications; and

wherein the flight controller is configured to:
provide the signals to the propulsion and directionality mechanisms of the unmanned aerial vehicle in accordance with the flight commands;
query status of the vehicle processor and, upon failing to receive an acceptable response from the vehicle processor, to perform a preconfigured flight operation.

Example Embodiment 26. The apparatus of Example Embodiment 25, wherein the flight controller is configured to authenticate flight commands of the vehicle processor and upon failing to authenticate the flight commands to perform the preconfigured flight operation.

Example Embodiment 27. The apparatus of Example Embodiment 20, further comprising:

a fuselage upon which the propulsion mechanism and the directionality mechanism are mounted;

a vehicle location determination processor configured to determine location of the vehicle with respect to three dimensions, wherein location of the vehicle with respect to at least two of the dimensions is obtained using a terrestrial or satellite navigation system, and wherein one of the three dimension is an altitude dimension, and wherein the altitude dimension is dependent upon information obtained from an onboard sensor of the vehicle.

Example Embodiment 28. The apparatus of Example Embodiment 20, wherein:

the flight controller is configured to provide signals to the propulsion mechanism and/or the directionality mechanism of the vehicle in accordance with at least one of native flight commands and vehicle processor commands;

a vehicle processor configured:
to engage in a first interaction with the communications circuitry and to obtain any infrastructure flight commands received from the entity supporting V2I communications;
to engage in a second interaction with the flight controller on the basis of vehicle processor flight commands including any infrastructure flight commands received from the entity supporting V2I communications;

an authentication processor configured to authenticate at least one of the first interaction and the second interaction.

Example Embodiment 29. The apparatus of Example Embodiment 28, further comprising a location determination unit (DLU) which engages in a third interaction with at least one of the flight controller and the vehicle processor, and wherein the authentication processor configured to authenticate at least one of the first interaction, the second interaction, and the third interaction.

Example Embodiment 30. A method in an unmanned aerial vehicle comprising:

a flight controller providing signals to propulsion and directionality mechanisms of the unmanned aerial vehicle;

detecting a fault in the vehicle or in a communications link between the vehicle and an entity supporting V2I communications; and

upon detecting the fault, directing the flight controller to follow a fault mode of operation for overriding propulsion and directionality of the unmanned aerial vehicle.

Example Embodiment 31. The method of Example Embodiment 30, wherein the fault is inoperability of the communications circuitry.

Example Embodiment 32. The method of Example Embodiment 30, wherein the fault comprises one or more of the following:

removal or inoperability of the antenna;

interference on the link between the vehicle and the entity supporting V2I communications;

a fault in random access memory (RAM) and/or read only memory (ROM) associated with the processor circuitry;

a virus inserted into software executed by the processor circuitry.

Example Embodiment 33. The method of Example Embodiment 30, further comprising directing communications circuitry to receive flight commands between vehicle and the entity supporting V2I communications and, upon inability to receive the flight commands, directing the flight controller to follow the default mode.

Example Embodiment 34. The method of Example Embodiment 30, wherein the fault mode of operation comprises one or more of the following:

a non-flight mode of operation of the unmanned aerial vehicle;

a descent mode of operation of the unmanned aerial vehicle; and

disablement of propulsion and directionality mechanisms of the unmanned aerial vehicle.

Various 3GPP documents that may be of interest to the technology disclosed herein include the following (all of which are incorporated herein by reference in their entireties):

3GPP TR 22.885, “Technical Specifications Group Service and System Aspects; Study on LTE support for V2X services”

### 3GPP TR 22.891, “Feasibility Study on New Services and Markets Technology Enablers; Stage 1”.

### 3GPP TR 22.861, “Feasibility Study on New Services and Markets Technology Enablers for Massive Internet of Things; Stage 1”.

### 3GPP TR 22.862, “Feasibility Study on New Services and Markets Technology Enablers—Critical Communications; Stage 1”

### 3GPP TR 22.863, “Feasibility Study on New Services and Markets Technology Enablers—Enhanced Mobile Broadband; Stage 1”

### 3GPP TR 22.864, “Feasibility Study on New Services and Markets Technology Enablers—Network Operation; Stage 1”

Other documents incorporated by reference herein and of possible interest include but are not limited to the following:
U.S. Pat. No. 9,412,279 to Kantor et al. Aug. 9, 2016
U.S. Pat. No. 9,412,278 to Gong Aug. 9, 2016
U.S. Pat. No. 9,218,232 to Khalastchi et al. Dec. 22, 2015
U.S. Pat. No. 7,454,255 to Boskovic et al. Nov. 18, 2008
U.S. Pat. No. 9,317,036 to Wang Apr. 19, 2016
United States Published Patent application 20090249129 to Femia

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
VEHICLE PROCESSING SYSTEM (VPU) PROCESSING LOOP

```
The VPU may from time to time generate VDO messages to transmit to the RSU (via the
V2I).
      If the V2I device reports to the VPU that it cannot receive any RSU signal,
            The VPU may command the V2I device to perform diagnostic self-tests
                  If the V2I report the results failure of self-test
                        The VPU may enter in FCS Prohibit mode.
                  If the V2I reports that it is operating per specification
                        The VPU may operate normally.
The VPU may from time to time receive a VCO with VPU Commands data object.
      If the VCO has VPU Commands requesting data from the VPU
            The VPU may generate and send back a VDO to the RSU (via the V2I).
      If the VCO has VPU Commands requesting data management at the VPU
            The VPU may update its internal memory per the VPU Commands
      If the VCO has VPU Commands requesting state management at the VPU
            The VPU may update its internal state per the VPU Commands (e.g. the
            VPU may be commanded to exit the FCS Command Mode)
The VPU may from time to time receive a VCO with a Flight Command data object.
      The reception of a Flight Command data object will cause the VPU to enter into
      a FCS Command Mode, and the VPU will execute the commands.
The VPU may from time to time, or upon receipt of a new CADO data object, compare
the location of the UAS to each CAS₁..CASₙ defined by each CADO in VPU memory to
determine an “Active CADO” and “Active CAS”:
      If the VPU determines that the UAS is NOT currently located in an area defined
      in any CAS's defined by any CADOs, then the VPU may enter into a FCS Open-
      Airspace Mode, and there is no “Active CADO” and no “Active CAS”.
      If the VPU determines that the UAS is currently located in an area defined in
      multiple CADO's (i.e. via CAS's in two or more CADOs that define the same
      area), then the VPU will select the CADO with the highest priority as the “Active
      CADO”. If the CADO's have the same priority, then the CADO with the most
      recent time stamp is selected as the as the “Active CADO”.
      If the VPU determines that the UAS is currently located in an area that is “Fully
      Contained” by one or more CAS's of a CADO, then the VPU will select the CAS
      with the more restrictive controlled airspace attributes as the “Active CAS”, and
      select that CADO as the “Active CADO”.
      If the VPU determines that the UAS is currently located in an area that is
      “Overlapped” by one or more CAS's of a CADO, then the VPU will select the
      CAS with the more restrictive controlled airspace attributes as the “Active CAS”,
      and select that CADO as the “Active CADO”.
      If the VPU determines that the UAS is currently located in an area that is “Not-
      Overlapped” by any other CAS's of a CADO, then the VPU will select the CAS
      as the “Active CAS”, and select that CADO as the “Active CADO”.
      The VPU may further consider the attributes associated with the Active CAS
      defined in the Active CADO.
          • If there are no attributes associated with the Active CAS, or the attributes
            indicate “Prohibited Flight Operations”, then the VPU may enter into a
            FCS Prohibited Mode.
          • If the attributes associated with the Active CAS indicate “Restricted
            Flight Operations”, then the VPU may enter in a FCS Restricted Mode.
          • If the attributes associated with the Active CAS indicate “Monitored
            Flight Operations”, then the VPU may enter into a FCS Monitored Mode.
If the VPU enters into FCS Open-Airspace Mode:
      The VPU will not command the FCS to execute any Flight Commands.
      The VPU may monitor for RSU broadcasts.
If the VPU enters into FCS Monitored Mode:
      The VPU will not command the FCS to execute any Flight Commands.
      The VPU may monitor for RSU broadcasts
      The VPU from time to time broadcast a VDO
If the VPU enters into FCS Command Mode:
      The VPU will remain only in FCS Command Mode until it receives a subsequent
      VCO with the VPU Command to “Exit FCS Command Mode”.
      The VPU may de-select the “Active CADO” and “Active CAS”, and the VPU
      may not subsequently select an “Active CADO” and “Active CAS” while the
      VPU remains in FCS Command Mode.
      If the VPU is processing a “Flight Profile” or “Autonomous Flight”
            The VPU may abandon those processes.
      The VPU will for each Flight Command in the Flight Command data object:
            Determine if the UAS in a nearly statically stable flight condition
                  Determine if the FCS has completed the prior Flight Command, if
                  any
                        Command the FCS to execute the next Flight Command
      The VPU may report to the RSU a VDO indicating that
          • The FCS has been commanded to execute the 1^{st}, 2^{nd}, ..., last Flight
            Command in the Flight Command data object
          • The FCS has completed the execution of 1^{st}, 2^{nd}, ..., last light Command
            in the Flight Command data object
If the VPU enters into FCS Restricted Mode:
      If the VPU determines that the flight state of the UAS is “Non-airborne”, then the
      VPU will enter into FCS Prohibit Mode.
      If the VPU determines that the flight state of the UAS is “airborne”, then the VPU
      may command the FCS per the content of the “Active CADO” and “Active CAS”:
            The VPU may attempt “Autonomous Flight” to navigate the UAS out of
            the controlled airspace defined by the “Active CAS”. VPU may report to
            the RSU a VDO indicating autonomous redirection (via Method [a || b ||
            c]) of the UAS from controlled airspace defined by the “Active CAS” in
            the “Active CADO”. The VPU may select one of several methods to
            navigate the UAS out of the “Active CAS”:
```

| | |
|---|---|
| a. | Execute an immediate 180degree turn (left or right). (This is a |
| | minimalistic profile, as it does not account for the UAS current flight |
| | state other than the UAS heading). |
| b. | Stabilize aircraft to horizontal flight, stabilize aircraft to constant |
| | heading, adjust flight speed to minimum controllable airspeed, and |
| | execute a turn (left or right) to a heading that is 180degees from the |
| | heading the UAS was on when it entered controlled airspace. |
| c. | Stabilize aircraft to horizontal flight, stabilize aircraft to constant |
| | heading, adjust flight speed to minimum controllable airspeed, |
| | execute turn (either left or right) to a heading that is perpendicular to |
| | the controlled airspace where the UAS entered the controlled |
| | airspace (e.g. if the horizontal plane of the polyhedron is oriented |
| | East and West, and the UAS crossed that plane on a heading of |
| | between 90 and 270 degrees true, then the heading to exit the |
| | controlled airspace perpendicular to the plane would be 0 degrees.). |

```
            If the VPU determines that the UAS has exited the “Active CAS”, the
            VPU may report to the RSU a VDO to indicate that transition, and then
            review again the set of CADO's to determine if a new “Active CADO”
            and “Active CAS” exist per the UAS current location.
            Note: The RSU may track the number of times that a UAS has entered
            and exited restricted airspace. The RSU may then determine that a
            maximum number of“air space violations” has occurred over some period
            of time, and the RSU may then decide to take over control of the UAS via
            an update to the UAS's active CADO.
If the VPU enters into FCS Prohibit Mode:
      If the flight state of the UAS is “Non-airborne”, the VPU will command the FCS
      to disable all flight control surfaces and propulsion mechanisms. The VPU will
      remain in the prohibit mode until the VPU is Power-cycled, and the system
      reboots (e.g. the device is power cycled).
      If the flight state of the UAS is “airborne”, then the VPU may command the FCS
      per the content of the “Active CADO”:
            If the “Active CADO” has a Flight Profile data object:
                  The VPU may command the FCS to execute the contents of the
                  Flight Profile data object. VPU may report to the RSU a VDO
                  indicating it is executing the CADO flight profile. The flight
                  profile may be a set of way-points (i.e. Latitude, Longitude,
                  Altitude), and the VPU will command the FCS to fly the UAS to
                  each of those waypoints until the last is reached. Once the last
                  waypoint is reached, the VPU may command the FCS to descend
                  at a minimum rate of decent until decent stops (i.e. on the ground)
                  and then disable all flight control surfaces. Alternately once the
                  last waypoint is reached, the VPU may command the FCS to fly
                  the UAS into a holding pattern by commanding the FCS to return
                  to either the first or an intermediate waypoint of the flight profile.
                  Once the VPU determines that FCS has completed the flight
                  profile the VPU may report to the RSU a VDO.
            If the “Active CADO” does NOT has a Flight Profile data object:
                  If the FCS is configured with an “Emergency Decent Mode”, the
                  VPU will command the FCS to execute it. Otherwise, the VPU
                  will command the FCS to disable all flight control surfaces and
                  propulsion mechanisms. The VPU will remain in the prohibit
                  mode until the VPU is Power-cycled, and the system reboots (e.g.
                  the device is power cycled).
```

What is claimed is:

1. An unmanned aerial vehicle comprising:
a flight controller configured to provide signals to propulsion and directionality mechanisms of the unmanned aerial vehicle;
communications circuitry configured to participate in vehicle-to-infrastructure (V2I) communications with an entity supporting V2I communications;
transceiver circuitry comprising an antenna configured to transceive wireless signals of the V2I communications; and
processor circuitry configured:
to detect a fault in the vehicle or in a communications link between the vehicle and the entity supporting V2I communications; and
upon detecting the fault, to direct the flight controller to follow a fault mode of operation for overriding propulsion and directionality of the unmanned aerial vehicle.

2. The apparatus of claim 1, wherein the processor circuitry is configured to perform a check of the communications circuitry to detect the fault.

3. The apparatus of claim 1, wherein the processor circuitry is configured to detect one or more of the following:
removal or inoperability of the antenna;
interference on the link between the vehicle and the entity supporting V2I communications; and
a fault in random access memory (RAM) and/or read only memory (ROM) associated with the processor circuitry;
a virus inserted into software executed by the processor circuitry.

4. The apparatus of claim 1, wherein the processor is configured to command the communications circuitry to receive flight commands between vehicle and the [PK1] entity supporting V2I communications and, upon inability to receive the flight commands, to direct the flight controller to follow the default mode.

5. The apparatus of claim 1, wherein the fault mode of operation comprises one or more of the following:
a non-flight mode of operation of the unmanned aerial vehicle;
a descent mode of operation of the unmanned aerial vehicle; and
disablement of propulsion and directionality mechanisms of the unmanned aerial vehicle.

6. The apparatus of claim 1, further comprising:
a vehicle processor configured to execute flight commands including any flight commands received via the communications circuitry from the entity supporting V2I communications; and
wherein the flight controller is configured to:
provide the signals to the propulsion and directionality mechanisms of the unmanned aerial vehicle in accordance with the flight commands;
query status of the vehicle processor and, upon failing to receive an acceptable response from the vehicle processor, to perform a preconfigured flight operation.

7. The apparatus of claim 6, wherein the flight controller is configured to authenticate flight commands of the vehicle processor and upon failing to authenticate the flight commands to perform the preconfigured flight operation.

8. The apparatus of claim 1, further comprising:
a fuselage upon which the propulsion mechanism and the directionality mechanism are mounted;
a vehicle location determination processor configured to determine location of the vehicle with respect to three dimensions, wherein location of the vehicle with respect to at least two of the dimensions is obtained using a terrestrial or satellite navigation system, and wherein one of the three dimension is an altitude dimension, and wherein the altitude dimension is dependent upon information obtained from an onboard sensor of the vehicle.

9. The apparatus of claim 1, wherein:
the flight controller is configured to provide signals to the propulsion mechanism and/or the directionality mechanism of the vehicle in accordance with at least one of native flight commands and vehicle processor commands;
a vehicle processor configured:
to engage in a first interaction with the communications circuitry and to obtain any infrastructure flight commands received from the entity supporting V2I communications;
to engage in a second interaction with the flight controller on the basis of vehicle processor flight commands including any infrastructure flight commands received from the entity supporting V2I communications;
an authentication processor configured to authenticate at least one of the first interaction and the second interaction.

10. The apparatus of claim 9, further comprising a location determination unit (DLU) which engages in a third interaction with at least one of the flight controller and the vehicle processor, and wherein the authentication processor configured to authenticate at least one of the first interaction, the second interaction, and the third interaction.

11. A method in an unmanned aerial vehicle comprising:
a flight controller providing signals to propulsion and directionality mechanisms of the unmanned aerial vehicle;
detecting a fault in the vehicle or in a communications link between the vehicle and an entity supporting V2I communications; and
upon detecting the fault, directing the flight controller to follow a fault mode of operation for overriding propulsion and directionality of the unmanned aerial vehicle.

12. The method of claim 11, wherein the fault is inoperability of the communications circuitry.

13. The method of claim 11, wherein the fault comprises one or more of the following:
interference on the link between the vehicle and the entity supporting V2I communications; and
a fault in random access memory (RAM) and/or read only memory (ROM) associated with the processor circuitry;
a virus inserted into software executed by the processor circuitry.

14. The method of claim 11, further comprising directing communications circuitry to receive flight commands between vehicle and the entity supporting V2I communications and, upon inability to receive the flight commands, directing the flight controller to follow the default mode.

15. The method of claim 11, wherein the fault mode of operation comprises one or more of the following:
a non-flight mode of operation of the unmanned aerial vehicle;
a descent mode of operation of the unmanned aerial vehicle; and
disablement of propulsion and directionality mechanisms of the unmanned aerial vehicle.
